(19) United States
(12) Patent Application Publication
(10) Pub. No.: US 2025/0118902 A1
(43) Pub. Date: Apr. 10, 2025

(54) METASURFACE STRUCTURE

(71) Applicant: FUJIFILM Corporation, Tokyo (JP)

(72) Inventors: Tatsuya YOSHIHIRO, Kanagawa (JP); Yukito SAITOH, Kanagawa (JP); Taketo OTANI, Kanagawa (JP); Makoto SHIMIZU, Kanagawa (JP); Shinichi KANNA, Kanagawa (JP)

(73) Assignee: FUJIFILM Corporation, Tokyo (JP)

(21) Appl. No.: 18/988,255

(22) Filed: Dec. 19, 2024

Related U.S. Application Data
(63) Continuation of application No. PCT/JP2023/027407, filed on Jul. 26, 2023.

(30) Foreign Application Priority Data
Jul. 27, 2022 (JP) 2022-119445
Feb. 14, 2023 (JP) 2023-020502

(51) Int. Cl. H01Q 15/10; H01Q 3/46

(52) U.S. Cl. CPC H01Q 15/10; H01Q 3/46

(57) ABSTRACT

A thin metasurface structure where a phase difference of transmitted electromagnetic waves is large and a transmittance with respect to the electromagnetic waves is also high. A metasurface structure that acts on electromagnetic waves having a frequency of 10 THz or less and is obtained by laminating a first structure layer where first metal microstructures are arranged, a second structure layer where second metal microstructures are arranged, a third structure layer where third metal microstructures are arranged, and a fourth structure layer where fourth metal microstructures are arranged to be spaced from each other.

### CROSS-REFERENCE TO RELATED APPLICATIONS

This application is a Continuation of PCT International Application No. PCT/JP2023/027407 filed on Jul. 26, 2023, which was published under PCT Article 21 (2) in Japanese, and which claims priority under 35 U.S.C. § 119 (a) to Japanese Patent Application No. 2022-119445 filed on Jul. 27, 2022 and Japanese Patent Application No. 2023-020502 filed on Feb. 14, 2023. The above applications are hereby expressly incorporated by reference, in their entirety, into the present application.

### BACKGROUND OF THE INVENTION

### 1. Field of the Invention

The present invention relates to a metasurface structure that refracts electromagnetic waves.

### 2. Description of the Related Art

High-frequency electromagnetic waves (millimeter waves, terahertz waves, and the like) used for high capacity wireless communication have high straightness, and thus it is necessary to control directivity to communication equipment.

In order to more efficiently control the directivity, electromagnetic waves emitted from a wave source need to be collimated by being refracted with a phase difference by an element having a convex lens effect.

In order to impart a phase difference to electromagnetic waves using a typical optical convex lens, a diffraction element, or the like, the element needs to have a size corresponding to the wavelength of target electromagnetic waves, which causes an increase in the size of the element.

On the other hand, as an element that is flat but acts a convex lens, a metasurface structure is known.

In the metasurface structure, for example, transmitted electromagnetic waves are imparted with a phase difference by microstructures arranged on a substrate such that the electromagnetic waves can be bent in a desired direction. Therefore, application of the metasurface structure to various elements such as a convex lens (condenser lens) or a deflection element is expected.

Here, in the metasurface structure, as described above, for example, a phase difference is imparted to the electromagnetic waves by the arranged microstructures such that the electromagnetic waves are, for example, refracted.

This metasurface structure is flat, does not require a thickness unlike a typical optical refractive lens, and also does not require formation of unevenness or the like having a steep groove structure unlike a diffraction lens (Fresnel lens).

That is, by using the metasurface structure, an element such as an extremely thin flat convex lens or a transmissive refraction plate capable of changing a traveling direction of radio waves to a desired direction can be implemented.

Here, in the metasurface structure of the related art, a sufficient phase difference cannot be imparted to particularly electromagnetic waves in a high frequency band called terahertz waves (THz waves), and there is also a case where a sufficient refractive index cannot be obtained.

On the other hand, Ruiqiang Zhao et al., High-efficiency Huygens' metasurface for terahertz wave manipulation, Optics Letters Vol. 44, Issue 14, pp. 3482-3485 (2019) discloses a metasurface structure where microstructures are arranged on both surfaces of a substrate.

### SUMMARY OF THE INVENTION

In a configuration including the metasurface structure described in Ruiqiang Zhao et al., High-efficiency Huygens' metasurface for terahertz wave manipulation, Optics Letters Vol. 44, Issue 14, pp. 3482-3485 (2019) where the microstructures are arranged on both surfaces of the substrate, a large phase difference can be imparted to even the terahertz waves as compared to a metasurface structure where the microstructures are arranged on only one surface of the substrate. However, even in this configuration, there are also many cases where a phase difference imparted to the terahertz waves may be insufficient.

Further, the transmissive element such as a convex lens requires not only a sufficient phase difference, that is, a sufficient refractive index but also a high transmittance. However, in the metasurface structure of the related art, it cannot be said that the transmittance is sufficient.

An object of the present invention is to solve the above-described problem of the related art and to provide a metasurface structure that is thinner than a typical optical convex lens or the like and where transmitted waves having a large phase difference from incident waves can be obtained and a transmittance with respect to electromagnetic waves is also high.

In order to achieve the object, the present invention has the following configurations.

[1] A metasurface structure that acts on electromagnetic waves having a frequency of 10 THz or less and is obtained by laminating a first structure layer, a second structure layer, a third structure layer, and a fourth structure layer to be spaced from each other,
the first structure layer being obtained by disposing a plurality of first metal microstructures in an in-plane direction,
the second structure layer being obtained by disposing a plurality of second metal microstructures in the in-plane direction,
the third structure layer being obtained by disposing a plurality of third metal microstructures in the in-plane direction, and
the fourth structure layer being obtained by disposing a plurality of fourth metal microstructures in the in-plane direction.

[2] The metasurface structure according to [1],
in which in at least one of the first structure layer, the second structure layer, the third structure layer, or the fourth structure layer, at least one metal microstructure is disposed to be shifted from the metal microstructure of another structure layer in the in-plane direction.

[3] The metasurface structure according to [2],
in which in all of the first structure layer, the second structure layer, the third structure layer, and the fourth structure layer, at least one metal microstructure is disposed to be shifted from the metal microstructure of another structure layer in the in-plane direction.

[4] The metasurface structure according to any one of [1] to [3], further comprising:
a dielectric layer that is provided in at least one of a position between the first structure layer and the second structure layer, a position between the second structure layer and the third structure layer, or a position between the third structure layer and the fourth structure layer.

[5] The metasurface structure according to any one of [1] to [4], further comprising:
a spacer that is provided in at least one of a position between the first structure layer and the second structure layer, a position between the second structure layer and the third structure layer, or a position between the third structure layer and the fourth structure layer.

[6] The metasurface structure according to any one of [1] to [5],
in which in at least one of the first structure layer, the second structure layer, the third structure layer, or the fourth structure layer, at least one metal microstructure is a metal cut wire.

[7] The metasurface structure according to any one of [1] to [6],
in which in all of the first structure layer, the second structure layer, the third structure layer, and the fourth structure layer, all of the metal microstructures are the metal cut wires.

[8] The metasurface structure according to [6] or [7],
in which a length of the metal cut wire is 0.1 to 1.0 time a wavelength of electromagnetic waves having a frequency at which a transmittance is highest.

[9] The metasurface structure according to any one of [1] to [8],
in which a thickness between the first structure layer and the second structure layer, a thickness between the second structure layer and the third structure layer, and a thickness between the third structure layer and the fourth structure layer are 30 nm to 30 mm.

[10] The metasurface structure according to any one of [1] to [9], which is a sheet type lens.

[11] The metasurface structure according to any one of [1] to [9], which is a transmissive refraction plate.

According to the present invention, it is possible to provide a metasurface structure that is thinner than a typical optical convex lens or the like and where transmitted waves having a large phase difference from incident waves can be obtained and a transmittance with respect to electromagnetic waves is also high.

### BRIEF DESCRIPTION OF THE DRAWINGS

FIG. 1 is a diagram conceptually showing an example of a metasurface structure according to the present invention.

FIG. 2 is a diagram conceptually showing another example of the metasurface structure according to the present invention.

FIG. 3 is a diagram conceptually showing another example of the metasurface structure according to the present invention.

FIG. 4 is a diagram conceptually showing another example of the metasurface structure according to the present invention.

FIG. 5 is a diagram conceptually showing another example of the metasurface structure according to the present invention.

FIG. 6 is a diagram conceptually showing the example of the metasurface structure according to the present invention.

FIG. 7 is a diagram conceptually showing an example of a sheet type lens having the metasurface structure according to the present invention.

FIG. 8 is a diagram conceptually showing the example of the sheet type lens having the metasurface structure according to the present invention.

FIG. 9 is a conceptual diagram showing Example of the present invention.

FIG. 10 is a conceptual diagram showing Example of the present invention.

FIG. 11 is a conceptual diagram showing Example of the present invention.

FIG. 12 is a conceptual diagram showing Example of the present invention.

FIG. 13 is a conceptual diagram showing Comparative Example of the present invention.

FIG. 14 is a conceptual diagram showing Comparative Example of the present invention.

FIG. 15 is a conceptual diagram showing a unit that configures a transmissive refraction plate according to Example of the present invention.

FIG. 16 is a conceptual diagram showing a sheet type lens according to Example of the present invention.

FIG. 17 is a conceptual diagram showing the sheet type lens according to Example of the present invention.

FIG. 18 is a schematic top view showing the sheet type lens according to Example of the present invention.

FIG. 19 is a conceptual diagram showing a method of measuring an electromagnetic wave focusing ability of the sheet type lens according to Example of the present invention.

FIG. 20 is a diagram showing measurement results of the electromagnetic wave focusing ability of the sheet type lens according to Example of the present invention.

FIG. 21 is a diagram showing measurement results of the electromagnetic wave focusing ability of the sheet type lens according to Example of the present invention.

FIG. 22 is a conceptual diagram showing a method of measuring a directivity improving effect of the sheet type lens according to Example of the present invention.

FIG. 23 is a diagram showing measurement results of the directivity improving effect of the sheet type lens according to Example of the present invention.

### DESCRIPTION OF THE PREFERRED EMBODIMENTS

Hereinafter, a metasurface structure according to the present invention will be described in detail based on preferable embodiments shown in the accompanying drawings.

In the present specification, numerical ranges represented by “to” include numerical values before and after “to” as lower limit values and upper limit values.

In the present specification, the meaning of “the same” includes a case where an error range is generally allowable in the technical field.

The following drawings are conceptual diagrams showing the metasurface structure according to the embodiment of the present invention. Accordingly, a shape, a size, and a thickness, of each of members, a positional relationship such as an interval or a position of each of layers in an in-plane direction, and the like do not necessarily match with the actual ones.

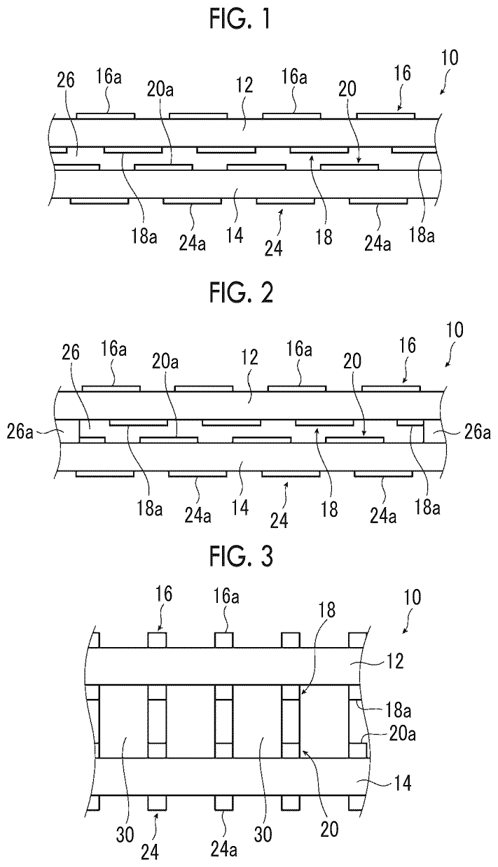

FIG. 1 is a diagram conceptually showing an example of the metasurface structure according to the embodiment of the present invention.

A metasurface structure 10 shown in FIG. 1 includes a first substrate 12, a second substrate 14, a first structure layer 16, a second structure layer 18, a third structure layer 20, a fourth structure layer 24, and a dielectric layer 26 provided between the first substrate 12 and the second substrate 14.

FIG. 1 conceptually shows a cross-section of the metasurface structure according to the embodiment of the present invention orthogonal to a thickness direction, that is, a lamination direction of the first structure layer 16 to the fourth structure layer 24 and taken along a longitudinal direction of first metal microstructures 16a to fourth metal microstructures 24a described below. However, in FIG. 1, in order to clearly show the configuration of the metasurface structure according to the embodiment of the present invention, hatching is not shown. Regarding this point, the same can also apply to FIGS. 2 to 6 and FIGS. 10 to 13.

The first structure layer 16 is formed using one surface (an upper surface in the drawing) of the first substrate 12, and a plurality of first metal microstructures 16a are arranged (disposed) on the surface of the first substrate 12.

The second structure layer 18 is formed using the other surface (a lower surface in the drawing) of the first substrate 12, and a plurality of second metal microstructures 18a are arranged (disposed) on the surface of the first substrate 12.

The third structure layer 20 is formed using one surface (an upper surface in the drawing) of the second substrate 14, and a plurality of third metal microstructures 20a are arranged (disposed) on the surface of the second substrate 14.

The fourth structure layer 24 is formed using the other surface (a lower surface in the drawing) of the second substrate 14, and a plurality of fourth metal microstructures 24a are arranged (disposed) on the surface of the second substrate 14.

The first substrate 12 and the second substrate 14 are laminated and fixed such that the dielectric layer 26 is sandwiched therebetween facing the second structure layer 18 and the third structure layer 20.

As a result, in the metasurface structure 10 in the example shown in the drawing, the first structure layer 16, the second structure layer 18, the third structure layer 20, and the fourth structure layer 24 are laminated to be spaced from each other.

The metasurface structure according to the embodiment of the present invention may include five or more structure layers as in Example 7 described below as long as it includes the first structure layer to the fourth structure layer.

Regarding the following description, the same also applies to the metasurface structure according to the embodiment of the present invention including five or more structure layers.

The metasurface structure 10 according to the embodiment of the present invention acts on electromagnetic waves having a frequency of 10 THz or less, that is, electromagnetic waves having a wavelength of 30 μm or more.

Specifically, the metasurface structure that acts on electromagnetic waves having a frequency of 10 THz or less refers to a structure that functions as a structure having a high refractive index with respect to electromagnetic waves having a frequency of 10 THz or less in a case where the electromagnetic waves are incident, in other words, a structure capable of obtaining a high diffraction angle.

The frequency of the electromagnetic waves on which the metasurface structure 10 according to the embodiment of the present invention acts does not have the lower limit, but it is preferable that the metasurface structure 10 according to the embodiment of the present invention acts on electromagnetic waves having a frequency of 10 GHz or more, that is, electromagnetic waves having a wavelength of 30 mm or less. It is more preferable that the metasurface structure 10 according to the embodiment of the present invention acts on electromagnetic waves having a frequency of 100 GHz or more, that is, electromagnetic waves having a wavelength of 3 mm or less.

That is, it is preferable that the metasurface structure 10 according to the embodiment of the present invention acts on electromagnetic waves having a frequency of 10 GHz to 10 THz, that is, so-called terahertz waves (THz waves).

The metasurface structure according to the embodiment of the present invention may focus, diffuse, unidirectionally refract electromagnetic waves having a frequency of 10 THz or less.

As described above, in the metasurface structure 10, the first substrate 12 that includes the first structure layer 16 on one surface and the second structure layer 18 on the other surface and the second substrate 14 that includes the third structure layer 20 on one surface and the fourth structure layer 24 on the other surface are laminated through the dielectric layer 26.

In the metasurface structure 10, both of the first substrate 12 and the second substrate 14 are substrates formed of a dielectric.

That is, in the metasurface structure 10 in the example shown in the drawing, the first substrate 12 acts as a dielectric layer that is provided between the first structure layer 16 and the second structure layer 18, and the second substrate 14 acts as a dielectric layer that is provided between the third structure layer 20 and the fourth structure layer 24.

In addition, the dielectric layer 26 is a dielectric layer that is provided between the second structure layer 18 and the third structure layer 20.

The metasurface structure 10 in the example shown in the drawing is not limited to the configuration where the first structure layer to the fourth structure layer are laminated to be spaced from each other by providing the metal microstructures on both surfaces of one substrate and laminating the two substrates to be spaced from each other.

For example, the metasurface structure according to the embodiment of the present invention may have a configuration where the first structure layer to the fourth structure layer are laminated to be spaced from each other by using four substrates including a substrate where the first structure layer is provided on one surface, a substrate where the second structure layer is provided on one surface, a substrate where the third structure layer is provided on one surface, and a substrate where the fourth structure layer is provided on one surface and laminating the four substrates such that the structure layers and the substrates face each other.

For example, the metasurface structure according to the embodiment of the present invention may have a configuration where the first structure layer to the fourth structure layer are laminated to be spaced from each other by using three substrates including a substrate where the first structure layer is provided on one surface and the second structure layer is provided on the other surface, a substrate where the third structure layer is provided on one surface, and a substrate where the fourth structure layer is provided on one surface and laminating the three substrates such that the structure layers and the substrates face each other.

Alternatively, the metasurface structure according to the embodiment of the present invention may have a configuration where the first structure layer to the fourth structure layer are laminated to be spaced from each other by applying a coating liquid including a composition of a dielectric for forming the substrate or a precursor thereof to one surface of a substrate on which the first structure layer is provided to form another substrate, providing the second structure layer on the formed substrate, and repeating this operation.

The first substrate 12, the second substrate 14, and the dielectric layer 26 are not limited, and various well-known sheet-like materials (film or plate-like material) formed of a dielectric can be used as long as they can allow transmission of the target electromagnetic waves.

Examples of the first substrate 12, the second substrate 14, and the dielectric layer 26 include a metal substrate including an oxide insulating layer such as a silicon substrate including silicon oxide, a substrate formed of an oxide such as silicon oxide, a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), a resin film such as a polyethylene terephthalate (PET) film, a polycarbonate film, a polyvinyl chloride film, a polyimide (PI) film, or a polytetrafluoroethylene (PTFE) film, and a glass plate.

In particular, for example, a cycloolefin polymer (COP) film, a cycloolefin copolymer (COC) film, or a PTFE film is preferable.

Materials for forming the first substrate 12 and the second substrate 14 may be typically the same as or different from each other.

In addition, the material for forming the first substrate 12 and/or the second substrate 14 may be same as or different from a material for forming the dielectric layer 26.

The thicknesses of the first substrate 12 and the second substrate 14 are not particularly limited and may be appropriately set depending the materials for forming the same and the like such that a sufficient action as a dielectric is exhibited and the first metal microstructures 16a, the second metal microstructures 18a, the third metal microstructures 20a, and the fourth metal microstructures 24a described below can be supported.

The thicknesses of the first substrate 12 and the second substrate 14 are preferably 0.001 times to 1 time and more preferably 0.01 times to 0.1 times with respect to the wavelength of electromagnetic waves having a frequency at which the transmittance of the metasurface structure 10 is the highest. That is, the thicknesses of the first substrate 12 and the second substrate 14 are preferably 30 nm to 30 mm, more preferably 0.3 μm to 3 mm, still more preferably 1 to 400 μm, and still more preferably 10 to 100 μm.

It is preferable that the thicknesses of the first substrate 12 and the second substrate 14 are set to be 0.001 times to 1 time with respect to the wavelength of electromagnetic waves having a frequency at which the transmittance of the metasurface structure 10 is the highest, that is, to be 30 nm to 30 mm from the viewpoints that, for example, electric resonance and magnetic resonance described below can be suitably generated to further increase a phase difference of the transmitted waves with respect to the incident waves, that is, the phase can be largely retarded to obtain a high refractive index and the transmittance with respect to the electromagnetic waves can be improved.

The thicknesses of the first substrate 12 and the second substrate 14 may be typically the same as or different from each other.

In addition, the thickness of the dielectric layer 26 is not limited and may be appropriately set depending on the material for forming the dielectric layer 26 and the like such that a sufficient action as a dielectric is exhibited.

The thickness of the dielectric layer 26 is preferably 0.001 times to 1 time and more preferably 0.01 times to 0.1 times with respect to the wavelength of electromagnetic waves having a frequency at which the transmittance of the metasurface structure 10 is the highest. That is, the thickness of the dielectric layer 26 is preferably 30 nm to 30 mm, more preferably 0.3 μm to 3 mm, still more preferably 1 to 1000 μm, and still more preferably 20 to 500 μm.

It is preferable that the thickness of the dielectric layer 26 is set to be 0.001 times to 1 time with respect to the wavelength of electromagnetic waves having a frequency at which the transmittance of the metasurface structure 10 is the highest, that is, to be 30 nm to 30 mm from the viewpoints that, for example, electric resonance and magnetic resonance described below can be suitably generated to further increase a phase difference of the transmitted waves with respect to the incident waves and the transmittance with respect to the electromagnetic waves can be improved.

Regarding this thickness, the same also applies to a case where an air layer described below is provided instead of the dielectric layer 26.

In the metasurface structure 10 shown in FIG. 1, by providing the dielectric layer 26 between the first substrate 12 and the second substrate 14, the second structure layer 18 and the third structure layer 20 are spaced from each other. However, the present invention is not limited to this example, and various configurations can be used.

For example, as conceptually shown in FIG. 2, by partially providing a dielectric layer 26a between the first substrate 12 and the second substrate 14, the dielectric layer 26a may function as a spacer to space the second structure layer 18 and the third structure layer 20 from each other. That is, in the present example, an air layer is present between the second structure layer 18 and the third structure layer 20 instead of the dielectric layer 26a.

In addition, as conceptually shown in FIG. 3, a column 30 formed of a dielectric such as a resin film may stand between the first substrate 12 and the second substrate 14 to avoid the third metal microstructures 20a and the fourth metal microstructures 24a, and the column 30 may function as a spacer to space the second structure layer 18 and the third structure layer 20 from each other.

Although described below, in the example shown in the drawing, all of the first metal microstructures 16a to the fourth metal microstructures 24a are metal cut wires, and are disposed such that a longitudinal direction thereof matches with a horizontal direction of FIG. 1 (FIG. 2). That is, FIG. 3 is a diagram conceptually showing a cross section of the metasurface structure according to the embodiment of the present invention taken from the orthogonal direction of FIG. 1, that is, the horizontal direction of FIG. 1.

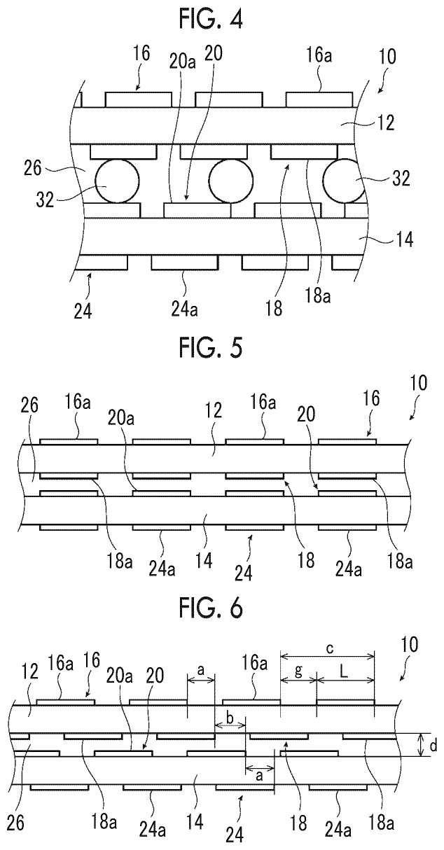

Further, by appropriately providing a spacer 32 as conceptually shown in FIG. 4, the second structure layer 18 and the third structure layer 20 may be spaced from each other.

In addition, for example, a frame such as a rectangular shape can also be used as the spacer. In this case, for example, a cross-shaped beam may be provided inside the frame.

The spacer may be formed of a dielectric such as an ultraviolet-curable resin.

The above-described method of spacing the second structure layer 18 and the third structure layer 20 can also be used for spacing the first structure layer 16 and the second structure layer 18 and for spacing the third structure layer 20 and the fourth structure layer 24.

As described above, in the first structure layer 16 of the metasurface structure 10, the plurality of first metal microstructures 16a are spaced from each other and arranged on one surface (in the drawing, the upper surface) of the first substrate 12. The first structure layer 16 is basically configured by arrangement of unit cells each of which is formed by one first metal microstructure 16a and a space around the first metal microstructure 16a.

In the second structure layer 18, the plurality of second metal microstructures 18a are spaced from each other and arranged on the other surface (the lower surface in the drawing) of the first substrate 12. The second structure layer 18 is basically configured by arrangement of unit cells each of which is formed by one second metal microstructure 18a and a space around the second metal microstructure 18a.

In the third structure layer 20, the plurality of third metal microstructures 20a are spaced from each other and arranged on one surface (the upper surface in the drawing) of the second substrate 14. The third structure layer 20 is basically configured by arrangement of unit cells each of which is formed by one third metal microstructure 20a and a space around the third metal microstructure 20a.

In the fourth structure layer 24, the plurality of fourth metal microstructures 24a are spaced from each other and arranged on the other surface (the lower surface in the drawing) of the second substrate 14. The fourth structure layer 24 is basically configured by arrangement of unit cells each of which is formed by one fourth metal microstructure 24a and a space around the fourth metal microstructure 24a.

As described above, in the metasurface structure 10 according to the embodiment of the present invention, all of the first structure layer 16 to the fourth structure layer 24 have the same basic structure in that the corresponding surfaces of the substrates are used and the first metal microstructures 16a to the fourth metal microstructures 24a are arranged on the respective surfaces.

Accordingly, in the following description, in a case where the first structure layer 16 to the fourth structure layer 24 do not need to be distinguished from each other, the first structure layer 16 to the fourth structure layer 24 will also be collectively referred to as “the structure layer”. Likewise, in a case where the first metal microstructures 16a to the fourth metal microstructures 24a do not need to be distinguished from each other, the first metal microstructures 16a to the fourth metal microstructures 24a will also be collectively referred to as “the metal microstructures”.

In the metasurface structure 10 according to the embodiment of the present invention, the structure layer has structurally the same configuration as a typically general metasurface structure (metamaterial) where microstructures (unit cells) are arranged on one surface of a substrate.

Accordingly, a shape of the metal microstructures, arrangement of the metal microstructures, an interval (pitch) of the metal microstructures, and the like are not limited.

In the metasurface structure 10 according to the embodiment of the present invention, the metal microstructures are formed of metal.

As described above, the metasurface structure according to the embodiment of the present invention acts on electromagnetic waves having a frequency of 10 THz or less. The metal has high conductivity and transmittance with respect to the electromagnetic waves having a frequency of 10 THz or less.

Therefore, in the metasurface structure 10 according to the embodiment of the present invention, by using the metal microstructure, the electromagnetic waves having a frequency of 10 THz or less can be efficiently refracted.

A material for forming the metal microstructure is not limited as long as it is metal, and various metals can be used.

Examples of the metal include copper, gold, silver, aluminum, platinum, and palladium.

In particular, copper, gold, silver, or the like having high conductivity is suitably used.

Likewise, the shape of the metal microstructures configuring the structure layer is not also limited, and various shapes that can be used as microstructures (resonators) in a well-known metasurface structure can be used.

Examples of the shape of the metal microstructures include a metal cut wire, a cross shape and a hooked cross shape where metal cut wires intersect each other, a cuboid shape, a cylindrical shape, a square plate shape, a V-shaped bottomed three-dimensional structure where cuboids are connected to end parts as described in JP2018-46395A, a H-shaped bottomed three-dimensional structure such as H-steel, and a substantially C-shaped bottomed three-dimensional structure such as a C-channel.

In addition, as the V-shaped bottomed three-dimensional structure or the cross-shaped bottomed three-dimensional structure shown in JP2018-46395A, various shapes where an angle between two cuboids is adjusted can be used.

In addition, a three-dimensional structure having a bottom surface shape shown in FIG. 5 of “Appl. Sci. 2018, 8 (9), 1689; https://doi.org/10.3390/app8091,689” can also be used.

In particular, a metal cut wire (rod-like metal wire) is suitably used.

The shape of the metal cut wire is not limited, and various pillar shapes such as a quadrangular pillar shape, a triangular pillar shape or a circular pillar shape can be used. In the quadrangular pillar, as a shape of a cross section in a direction orthogonal to the longitudinal direction, various shapes such as a square shape, a rectangular shape, a parallelogram shape, or a trapezoidal shape can be used. In addition, likewise, even in the triangular pillar, various shapes such as a regular triangular shape or an isosceles triangular shape, can be used. Even in the circular pillar, not only a circular shape but also an elliptical shape can be used.

In one structure layer, only one type of metal microstructures may be used, or plural types of microstructures may be used in combination. In addition, in one structure layer, metal microstructures having the same type but different sizes may be used in combination. For example, in a case where the metal microstructures are metal cut wires, in one structure layer, plural types of metal cut wires that are different in one or more among the length, the width, and the thickness may be used in combination.

In addition, the metal microstructures of the respective structure layers may be the same as or different from each other.

Here, it is preferable that at least one of the first structure layer 16, the second structure layer 18, the third structure layer 20, or the fourth structure layer 24 includes at least one metal cut wire as the metal microstructure.

In addition, it is more preferable that all of the structure layers include at least one metal cut wire as the metal microstructure.

By using the metal cut wire as the metal microstructure, an increase in effective dielectric constant caused by electric resonance and an increase in effective permeability caused by magnetic resonance described below can be more suitably achieved at the same time. As a result, by increasing an effective refractive index represented by the square root of the product of the effective dielectric constant and the effective permeability with respect to the electromagnetic waves having a frequency of 10 THz or less, a phase difference of the transmitted waves with respect to the incident waves increases. Further, by matching an effective impedance represented by the square root of a ratio of the effective dielectric constant to the effective permeability to that of the surrounding medium, reflection of the electromagnetic waves can be suppressed, and the transmittance with respect to the electromagnetic waves can also be improved. From these viewpoints and the like, it is preferable to use the metal cut wire as the metal microstructure.

It is preferable that, in at least one structure layer including the metal cut wire as the metal microstructure, all of the metal microstructures are metal cut wires.

It is more preferable that, in the structure layers including the metal cut wire as the metal microstructure, all of the metal microstructures are metal cut wires.

Further, it is still more preferable that, in the metasurface structure according to the embodiment of the present invention, all of the metal microstructures are metal cut wires.

It is preferable that, in at least one structure layer including the metal cut wire as the metal microstructure, longitudinal directions of all of the metal cut wires are the same in the in-plane direction.

In addition, it is more preferable that, in the structure layers including the metal cut wire as the metal microstructure, longitudinal directions of all of the metal cut wires are the same in the in-plane direction.

It is still more preferable that longitudinal directions of all of the metal cut wires are the same in the in-plane direction, and it is still more preferable that all of the metal microstructures are metal cut wires and longitudinal directions of all of the metal cut wires are the same in the in-plane direction.

In a case where the metal cut wires are used as the metal microstructures, the lengths of all the metal cut wires may be the same, or metal cut wires having different lengths may be mixed.

In a case where the metal cut wires are used as the metal microstructures, the thicknesses of all the metal cut wires may be the same, or metal cut wires having different thicknesses may be mixed.

Further, shapes of upper and lower surfaces of all of the metal cut wires may be the same, or metal cut wires having different shapes of upper and lower surfaces may also be mixed.

In the metasurface structure 10 according to the embodiment of the present invention, the size of the metal microstructures is not limited but is less than or equal to the wavelength of the target electromagnetic waves as in the typical metasurface structure (metamaterial) and is preferably 1.0 time or less and more preferably 0.5 times or less with respect to the wavelength.

For example, in a case where the metal microstructures are the metal cut wires, the length (for example, the length L) of the metal cut wires is preferably 0.1 times to 1.0 time and more preferably 0.25 times to 0.5 times with respect to the wavelength of electromagnetic waves having a frequency at which the transmittance of the metasurface structure 10 is the highest.

This configuration is preferable from the viewpoints that, for example, electric resonance and magnetic resonance described below capable of efficiently performing phase modulation of transmitted waves using resonance by the metal microstructures can be suitably generated to further increase a phase difference of the transmitted waves with respect to the incident waves, and the transmittance with respect to the electromagnetic waves can be improved.

Regarding the length of the metal cut wires, the same also applies to the other metal microstructures. In these metal microstructures, the length in a direction along polarized waves of the incident waves (incident electromagnetic waves) may be replaced with the length of the metal cut wires.

In addition, the thickness of the metal cut wires is not limited and may be appropriately set depending on the material for forming the metal cut wires and the like such that a sufficient action as a metasurface structure is exhibited. The thickness of the metal cut wires is preferably is more than ¼ of a skin depth determined by the wavelength of the electromagnetic waves, the permeability, and the conductivity. That is, the thickness of (unit [m]) of the metal cut wires is preferably more than 1/20000000, more preferably more than 1/5000000, and more preferably more than 1/2500000 with respect to the square root of a wavelength of electromagnetic waves having the lowest frequency for typical metal in a case where the wavelength is represented by the unit mm. In addition, the thickness of the metal cut wires is preferably less than ¼, more preferably less than 1/20, and more preferably less than 1/100 with respect to the wavelength of the electromagnetic wave having the highest frequency.

The skin depth δ can be represented by the following expression, where σ represents the conductivity, μ represents the permeability, and ω represents an angular frequency (Ω=2πc/λ, where c represents the light speed and λ represents the wavelength).

$$δ = \sqrt{\frac{2}{μ σ ω}}$$

In addition, as described above, the thickness is the size in the lamination direction of the first structure layer 16 to the fourth structure layer 24.

Further, the width (a width W described below) of the metal cut wires is not particularly limited and is preferably about 0.01 to 1 time and more preferably about 0.05 to 0.2 times with respect to the length of the metal cut wires.

In the above description, the electromagnetic waves having the lowest frequency (the highest frequency) refers to electromagnetic waves having the lowest frequency (the highest frequency) at which desired refractivity can be obtained in the metasurface structure. For example in a case where the lower limit of the frequency of the electromagnetic waves on which the metasurface structure acts is 10 GHz, the electromagnetic waves having the lowest frequency refer to electromagnetic waves having a frequency of 10 GHz, that is, a wavelength of 30 mm.

An actual metasurface structure operates satisfactorily only in a limited frequency range (for example, a range of a central frequency±20%). In consideration of this point, it can also be said that the lowest frequency is “the lower limit of a designed frequency in a case where a specific metasurface structure is designed”. For example, in a case where the designed metasurface structure is “a lens for terahertz waves”, “a lens for millimeter waves”, or the like, the frequency of the lower limit that is shown as a specification where the lens is operable is “the lowest frequency” of the electromagnetic waves.

In the metasurface structure 10 shown in FIG. 1, the first metal microstructures 16a, the second metal microstructures 18a, the third metal microstructures 20a, and the fourth metal microstructures 24a are disposed to be shifted from each other in the in-plane direction of the first substrate 12 and the second substrate 14.

In other words, in a case where the metasurface structure 10 is seen from the normal direction of the substrate, the first metal microstructures 16a, the second metal microstructures 18a, the third metal microstructures 20a, and the fourth metal microstructures 24a do not completely overlap each other.

In addition, the normal direction is a direction orthogonal to a main surface of a sheet-like material, and is the thickness direction in the metasurface structure 10, that is, the lamination direction of the structure layers, and that is, the lamination direction of the first substrate 12, the dielectric layer 26, and the second substrate 14.

In addition, the main surface is the maximum surface of a sheet-like material and is usually both surfaces in the thickness direction.

The present invention is not limited to this configuration, and as conceptually shown in FIG. 5, the first metal microstructures 16a, the second metal microstructures 18a, the third metal microstructures 20a, and the fourth metal microstructures 24a may be disposed to match with each other in the in-plane direction of the first substrate 12 and the second substrate 14.

That is, in a case where the metasurface structure according to the embodiment of the present invention is seen from the normal direction of the substrate, the first metal microstructures 16a, the second metal microstructures 18a, the third metal microstructures 20a, and the fourth metal microstructures 24a may completely overlap each other.

In the following description, the in-plane direction of the first substrate 12 and the second substrate 14 will also be simply referred to as “in-plane direction”.

However, in the present invention, in at least one type of the first metal microstructures 16a, the second metal microstructures 18a, the third metal microstructures 20a, or the fourth metal microstructures 24a, it is preferable that at least one metal microstructure is disposed to be shifted from the metal microstructure of another structure layer in the in-plane direction. In other words, in the present invention, in at least one of the first structure layer 16, the second structure layer 18, the third structure layer 20, or the fourth structure layer 24, it is preferable that a position of at least one metal microstructure in the in-plane direction is shifted from the metal microstructure of another structure layer.

That is, in the present invention, in at least one of the first structure layer 16, the second structure layer 18, the third structure layer 20, or the fourth structure layer 24, the metal microstructures of which the positions in the in-plane direction are shifted from those of another at least one layer and the metal microstructures of which the positions in the in-plane direction match with those of another at least one layer may be mixed.

In the present invention, in a case where the positions of the metal microstructures in one structure layer are shifted from those of another structure layer in the in-plane direction, a part of the metal microstructures are present at the same positions in the in-plane direction, and the other microstructures are present at different positions in the in-plane direction. In other words, in the present invention, the positions of the metal microstructures in one structure layer being shifted from those of another structure layer in the in-plane direction represents a state where, in case of being seen from the normal direction of the substrate, a part of the metal microstructures overlap each other, but all of the metal microstructure do not overlap each other and some of the metal microstructures do not overlap each other.

In addition, in the present invention, the positions of the metal microstructures in one structure layer are shifted from those of another structure layer in the in-plane direction also includes a case where positions of end parts in the in-plane direction match with each other, but the positions in the in-plane direction do not completely overlap each other due to a difference in size. For example, in a case where the metal microstructures are the metal cut wires, there is also a case where, in one structure layer and another structure layer, one ends of the metal cut wires match with each other in the in-plane direction, but other ends of the metal cut wires do not overlap each other in the in-plane direction due to a different in length.

Further, in the present invention, in the fourth structure layers including the first structure layer 16, the second structure layer 18, the third structure layer 20, and the fourth structure layer 24, the direction in which the metal microstructures in one structure layer are shifted from those in another structure layer in the in-plane direction is not limited.

For example, in a case where one and another directions of the two-dimensional arrangement of the metal microstructures are x and y directions, the direction in which the metal microstructures in one structure layer are shifted from those in another structure layer in the in-plane direction may be only the x direction, may be only the y direction, or may be both of the x direction and the y direction. In the two-dimensional arrangement of the metal microstructures, the x direction and the y direction may be or may not be orthogonal to each other.

In addition, in a case where the metal microstructures are the metal cut wires, the direction in which the positions of the metal cut wires in one structure layer are shifted from those in another structure layer may be only the length direction, may be only the width direction, or may be both of the length direction and the width direction.

Regarding the above-described points, the same also applies to a case where the metasurface structure according to the embodiment of the present invention includes four or more structure layers.

In the metasurface structure according to the present invention, with the above-described configuration, an increase in effective dielectric constant caused by electric resonance and an increase in effective permeability caused by magnetic resonance described below can be more suitably achieved at the same time. As a result, by increasing an effective refractive index represented by the square root of the product of the effective dielectric constant and the effective permeability with respect to the electromagnetic waves having a frequency of 10 THz or less, a phase difference of the transmitted waves with respect to the incident waves increases. Further, by matching an effective impedance represented by the square root of a ratio of the effective dielectric constant to the effective permeability to that of the surrounding medium, reflection of the electromagnetic waves can be suppressed, and the transmittance with respect to the electromagnetic waves can also be improved.

In the metasurface structure according to the embodiment of the present invention, in at least one type of the first metal microstructures 16a to the fourth metal microstructures 24a, it is preferable that at least one metal microstructure is disposed to be shifted from the metal microstructure of another structure layer in the in-plane direction.

In particular, in the second metal microstructures 18a and the third metal microstructures 20a, it is preferable that at least one metal microstructure is disposed to be shifted in the in-plane direction. That is, in the second structure layer 18 and the third structure layer 20, it is preferable that at least one metal microstructure is disposed to be shifted in the in-plane direction.

In addition, in the metasurface structure according to the embodiment of the present invention, it is preferable that the number of the metal microstructures disposed to be shifted in the in-plane direction from the metal microstructures of another structure layer among the first metal microstructures 16a to the fourth metal microstructures 24a is large. That is, it is more preferable that three or more types of metal microstructures among the first metal microstructures 16a to the fourth metal microstructures 24a are disposed to be shifted from the metal microstructures of the other structure layer in the in-plane direction. In particular, as in the metasurface structure 10 shown in FIG. 1, it is still more preferable that all of the metal microstructures are disposed to be shifted from the metal microstructures of the other structure layers in the in-plane direction.

In other words, in the present invention, it is more preferable that, in three or more structure layers, at least one metal microstructure of one structure layer is disposed to be shifted from the metal microstructure of another structure layer in the in-plane direction. In particular, in the present invention, it is still more preferable that, in all of the four structure layers, at least one metal microstructure is disposed to be shifted from the metal microstructure of another structure layer in the in-plane direction.

In one structure layer, one metal microstructure or all of the metal microstructures may be disposed to be shifted from the metal microstructure of another structure layer in the in-plane direction.

For example, in a case where the metasurface structure is a condenser lens, in one structure layer, the metal microstructures may be disposed to be shifted from the metal microstructure of another structure layer in the in-plane direction in a center region (the vicinity of an optical axis) where a phase difference of the transmitted waves with respect to the incident waves needs to be large, and the metal microstructures may be disposed to match with the metal microstructures of another structure layer in the in-plane direction in a peripheral portion.

The amount of shift of the metal microstructures from the metal microstructures of another structure layer in the in-plane direction may be uniform or may vary between regions.

For example, in a case where the metasurface structure is a condenser lens, the amount of shift of the metal microstructures from the metal microstructures of another structure layer in the in-plane direction may be set to be large in a center region (the vicinity of an optical axis) where a phase difference of the electromagnetic waves with respect to the incident waves needs to be large, and the amount of shift may gradually decrease continuously or stepwise toward a peripheral region.

The amounts of shift of the metal microstructures in the in-plane direction may be the same or different between combinations of two structure layers.

For example, the amount of shift of the metal microstructures between the first structure layer 16 and the second structure layer 18 may be the same as or different from the amount of shift of the metal microstructures between the second structure layer 18 and the third structure layer 20.

The amount of shift of the metal microstructures in the in-plane direction is not limited and may be appropriately set depending on the use, the required performance, and the like of the metasurface structure.

For example, a case where the metal microstructures are metal cut wires and longitudinal directions of all of the metal microstructures match with each other in the in-plane direction will be described as an example. The following dimensions are all the dimensions in the longitudinal direction of the metal cut wires except for the thickness of the dielectric layer 26.

As conceptually shown in FIG. 6, the length of the metal microstructures is represented by L, the interval of the metal microstructures is represented by g, and the arrangement period of the metal microstructures, that is, the sum of the length L and the interval g is represented by c.

In the present example, the length L of the metal microstructures, the interval g of the metal microstructures, and the arrangement period c are uniform in all of the structure layers, and the amount of shift between the first metal microstructures 16a and the second metal microstructures 18a and the amount of shift between the third metal microstructures 20a and the fourth metal microstructures 24a are represented by a.

The amount of shift between the second metal microstructures 18a and the third metal microstructures 20a is represented by b.

Further, the thickness of the dielectric layer 26 (the interval between the first substrate 12 and the second substrate 14) is represented by d.

In this case, in the metasurface structure according to the embodiment of the present invention, it is preferable that the amount of shift b and the arrangement period c satisfy

$$\vert b / c \vert < 0.25 .$$

In the metasurface structure according to the embodiment of the present invention, it is preferable to satisfy the above expression from the viewpoint that, for example, a phase difference of the transmitted waves with respect to the incident waves increases for the electromagnetic waves having a frequency of 10 THz or less, and the transmittance with respect to the electromagnetic waves can be improved.

Further, in the metasurface structure according to the embodiment of the present invention, it is preferable that the amount of shift a, the amount of shift b, the arrangement period c, and the thickness d satisfy

$${( [ a / c ] - 0.5 )}^{2} / {( f ( d ) / c )}^{2} + {( b / c )}^{2} / {( 0.25 )}^{2} < 1$$

$$where$$

$$f ( d ) = 1.167 \times 1 {0}^{- 4} {d}^{2} + 5.500 \times 1 {0}^{- 3} d + 0.093 .$$

In the metasurface structure according to the embodiment of the present invention, it is preferable to satisfy the above expression from the viewpoint that, for example, a phase difference of the transmitted waves with respect to the incident waves increases for the electromagnetic waves having a frequency of 10 THz or less, and the transmittance with respect to the electromagnetic waves can be improved.

As described above, the metasurface structure according to the embodiment of the present invention is a metasurface structure that acts on electromagnetic waves having a frequency of 10 THz or less and is obtained by laminating a first structure layer, a second structure layer, a third structure layer, and a fourth structure layer to be spaced from each other, the first structure layer being obtained by arranging first metal microstructures in an in-plane direction, the second structure layer being obtained by arranging second metal microstructures in the in-plane direction, the third structure layer being obtained by arranging third metal microstructures in the in-plane direction, and the fourth structure layer being obtained by arranging fourth metal microstructures in the in-plane direction.

In the metasurface structure according to the embodiment of the present invention shown in FIGS. 1 to 5, four structure layers are laminated to be spaced from each other by including the first structure layer 16 where the plurality of first metal microstructures 16a are arranged on one surface of the first substrate 12, the second structure layer 18 where the plurality of second metal microstructures 18a are arranged on the other surface of the first substrate 12, the third structure layer 20 where the plurality of third metal microstructures 20a are arranged on one surface of the second substrate 14, and the fourth structure layer 24 where the plurality of fourth metal microstructures 24a are arranged on the other surface of the second substrate and laminating the first substrate 12 and the second substrate 14 with the dielectric layer 26 interposed therebetween.

In the metasurface structure according to the embodiment of the present invention, by including four (four or more) structure layers where the metal microstructures are arranged as described above, a high refractive index can be implemented by imparting a large phase difference to the incident electromagnetic waves having a frequency of 10 THz or less, and high transmittance with respect to the electromagnetic waves can be implemented.

As is well known, in the typical metasurface structure, by arranging the microstructures that are smaller than the wavelength of the target electromagnetic waves on the surface of the substrate, a phase difference is imparted to the transmitted electromagnetic waves using resonance by the microstructures due to the arrangement of the unit cells each of which consists of one microstructure and a space around the microstructure, and the electromagnetic waves are refracted according to Huygens principle by phase modulation.

With the typical metasurface structure, a sufficient refractive index cannot be obtained with respect to terahertz waves. On the other hand, as also disclosed in Ruiqiang Zhao et al., High-efficiency Huygens' metasurface for terahertz wave manipulation, Optics Letters Vol. 44, Issue 14, pp. 3482-3485 (2019), even in the metasurface structure where the microstructures are arranged on both surfaces of the one substrate, a large phase difference can be obtained.

However, according to an investigation by the present inventors, even with the metasurface structure described in Ruiqiang Zhao et al., High-efficiency Huygens' metasurface for terahertz wave manipulation, Optics Letters Vol. 44, Issue 14, pp. 3482-3485 (2019) where the microstructures are arranged on both surfaces of the substrate, a phase difference obtained with respect to terahertz waves is about 160°, and a sufficient phase difference cannot be always obtained.

On the other hand, the metasurface structure according to the embodiment of the present invention includes four structure layers where the metal microstructures are arranged. As a result, a large phase difference, for example, a phase difference of 360° or more can be imparted to terahertz waves to be transmitted.

Hereinafter, the description will be made with reference to FIG. 5.

In a case where electromagnetic waves having a frequency of 10 THz or less are incident on the metasurface structure according to the embodiment of the present invention, as in the typical metasurface structure, electric resonance is generated by the metal microstructures due to the arrangement of the unit cells in the structure layers such that a phase difference is imparted to the transmitted electromagnetic waves.

Here, focusing on the first metal microstructure 16a on the leftmost side in the drawing, in a case where an electromagnetic wave is incident, a portion having a high voltage is generated at both ends of the first metal microstructure 16a. Likewise, even in the second metal microstructure 18a on the leftmost side of the drawing, a portion having a high voltage is generated at both ends. This voltage is inverted in polarity due to a change in phase during passage of the electromagnetic wave. For example, in the first metal microstructure 16a, the voltage is positive on the right side of the drawing, and is negative on the left side of the drawing. In the second metal microstructure 18a, the voltage is negative on the right side of the drawing, and is positive on the left side of the drawing.

As a result, a clockwise loop current is generated between the first metal microstructure 16a and the second metal microstructure 18a. In a case where the loop current flows, a magnetic field is generated according to the direction of the loop current based on the corkscrew rule. As a result, as if a magnetic material was present, magnetic resonance where a magnetic field is strengthened in a direction orthogonal to an electric field occurs.

The electric resonance and the magnetic resonance also occur in the third metal microstructures 20a and the fourth metal microstructures 24a on the second substrate 14 side.

Further, in the metasurface structure according to the embodiment of the present invention where the four structure layers are laminated, the second metal microstructures 18a on the first substrate 12 side and the third metal microstructures 20a on the second substrate 14 side are present adjacent to each other. Therefore, the electric resonance and the magnetic resonance also occur in the second metal microstructures 18a on the first substrate 12 side and the third metal microstructures 20a on the second substrate 14 side. As a result, electric resonance and magnetic resonance can be further obtained as compared to a case where the first substrate and the second substrate are present independent of each other. This effect can be more suitably obtained in a case where the second metal microstructures 18a on the first substrate 12 side and the third metal microstructures 20a on the second substrate 14 side are adjacent to each other at a distance of preferably 1 time or less and more preferably 0.1 times or less the wavelength of the electromagnetic waves.

In order to increase the transmittance with respect to the electromagnetic waves such as terahertz waves, it is necessary to match the effective impedance of the metasurface structure to that of the surrounding medium. To that end, it is necessary to generate electric resonance and magnetic resonance at the same time.

In the metasurface structure according to the embodiment of the present invention where the four structure layers are laminated, electric resonance and magnetic resonance are generated between the structure layers as described above. Therefore, the electric resonance and the magnetic resonance are generated with a very good balance. As a result, with the metasurface structure according to the embodiment of the present invention, transmitted waves with a large phase difference, for example, a phase difference of 360° or more with respect to the electromagnetic waves (incident waves) having a frequency of 10 THz or less can be obtained, and high transmittance with respect to the electromagnetic waves can also be obtained.

Further, the metal microstructures having high conductivity with respect to the electromagnetic waves having a frequency of 10 Thz or less are used as the microstructures. Therefore, the electric resonance and the magnetic resonance are generated with high efficiency.

Further, preferably, in one type or more of the first metal microstructures 16a to the fourth metal microstructures 24a, by disposing at least one metal microstructure to be shifted from the metal microstructure of another structure layer in the plane, the above-described effects can be more suitably obtained. In particular, as shown in FIG. 1 or the like, in all of the first metal microstructures 16a to the fourth metal microstructures 24a, by disposing at least one metal microstructure to be shifted from the metal microstructure of another structure layer in the plane, the above-described effects can be more suitably obtained.

In addition, the metasurface structure according to the embodiment of the present invention has the configuration where the structure layers obtained by arranging the metal microstructures are laminated on the substrate. Therefore, the thickness is significantly thinner as compared to a typical optical lens or the like. That is, the metasurface structure according to the embodiment of the present invention including the four structure layers can be used as a sheet type element.

As a result, the metasurface structure according to the embodiment of the present invention can be used as various well-known elements such as a convex lens, a concave lens, a transmissive refraction plate capable of changing a traveling direction of electromagnetic waves to a desired direction, or a deflection element that bends electromagnetic waves.

The action of the metasurface structure according to the embodiment of the present invention on the electromagnetic waves having a frequency of 100 THz or less can be set by appropriately selecting and combining the shape of the metal microstructures in each of the structure layers, the material for forming the same, the arrangement of the metal microstructures, the interval of the metal microstructures, and the like. In other words, the element as which that the metasurface structure according to the embodiment of the present invention acts on the electromagnetic waves having a frequency of 100 THz or less can be set by appropriately selecting and combining the shape of the metal microstructures in each of the structure layers, the material for forming the same, the arrangement of the metal microstructures, the interval of the metal microstructures, and the like.

That is, in the metasurface structure according to the embodiment of the present invention, the metal microstructures to be used, the arrangement of the metal microstructures in each of the structure layers, and the like may be set using a well-known method such that desired characteristics of the metasurface structure can be obtained.

For example, in the metasurface structure according to the embodiment of the present invention, by regularly arranging the same unit cells in each of the structure layers, the metasurface structure may be used as a phase difference plate.

Alternatively, by arranging unit cells having different characteristics in at least one of the structure layers and adjusting the magnitude of the phase difference to be imparted to the transmitted electromagnetic waves in the plane of the structure layer, the metasurface structure according to the embodiment of the present invention may be used as a metasurface structure (element) having desired characteristics, for example, a lens or a transmissive refraction plate. In other words, by arranging unit cells having different characteristics in at least one of the structure layers and providing a distribution of the phase difference to be imparted to the transmitted electromagnetic waves in the plane of the structure layer, the metasurface structure according to the embodiment of the present invention may be used as a metasurface structure having desired characteristics.

In an aspect using the unit cells having different characteristics, one structure layer may include the same unit cells.

In the metasurface structure according to the embodiment of the present invention using the unit cells having different characteristics, the unit cells may be arranged such that the characteristics change regularly, may be arranged such that the characteristics change irregularly, or may be arranged such that a region where the characteristics change regularly and a region where the characteristics change irregularly are mixed. The regular change in the characteristics of the unit cells may be continuous or stepwise. Regarding the arrangement of the unit cells, the same also applies in the following units.

In addition, in the aspect using the unit cells having different characteristics, the structure layer may be configured by using a plurality of unit cells having different characteristics as one unit and repeatedly arranging the units two-dimensionally. In one unit, all of the unit cells may be different from each other, or the same unit cells may be provided in the unit.

This way, in the configuration where the plurality of unit cells are repeatedly disposed, the units configuring the structure layer may be one type.

Alternatively, in the configuration where the units including the plurality of unit cells are repeatedly disposed, plural types of units including unit cells having different characteristics may be used. In this case, the plural types of units may be regularly arranged to configure the structure layer, the plural types of units may be irregularly arranged to configure the structure layer, or the regular arrangement of the units and the irregular arrangement of the units may be combined to configure the structure layer.

In addition, in the configuration where the units are arranged to form the structure layer, all of the structure layers may be configured with the same units, or in one or more structure layer, units different from those of other structure layers may be used. Even in a case where all of the structure layers are configured with the same units, the units (metal microstructures) configuring each of the structure layers may be shifted from the units of another structure layer in the in-plane direction.

Here, in a case where different units are used for the respective structure layers, as conceptually shown in FIG. 16 described below, a configuration can also be used, in which end parts (one ends or both ends) of the metal microstructures match with each other in the in-plane direction in the units that overlap each other in the plurality of structure layers, and the metal microstructures in the units are shifted from each other in the in-plane direction. This configuration can be implemented by adjusting the length (size) of the metal structures, the amount of shift in the in-plane direction, and the like.

The use of this configuration can be suitably deal with, for example, a case where a phase difference to be imparted to the transmitted electromagnetic waves is desired to change from a center portion toward a peripheral portion. That is, in this configuration, end parts in the in-plane direction of the units adjacent to each other in the structure layers match with each other. In other words, in the configuration, in the in-plane direction, each of the structure layers has a cut of the unit that matches with that of another structure layer. Therefore, in the configuration, in each of the structure layers, the metal microstructures (unit cells) having different amounts of shift can be easily and independently disposed in each of the units without considering the positions (amount of shift) of the metal microstructures in the adjacent unit. As a result, the use of the configuration can suitably deal with a configuration or the like where characteristics to be imparted to the transmitted electromagnetic waves are desired to change gradually in one direction.

The characteristics of the unit cells are specifically the magnitude of the phase difference to be imparted to the transmitted electromagnetic waves by the unit cells.

The characteristics of the unit cells, that is, the magnitude of the phase difference to be imparted to the transmitted electromagnetic waves by the unit cells can be adjusted, for example, selecting the sizes of the metal microstructures such as the length, the width, and the thicknesses of the metal cut wires, selecting the type of the metal microstructures to be used, selecting the interval of the metal microstructures in the adjacent unit cell, selecting the direction of the metal microstructures in the unit cell, and selecting a material of an object present between the metal microstructures and whether a gap is present therebetween.

In the metasurface structure according to the embodiment of the present invention, as described above, a larger phase difference than that in the related art can be imparted to the transmitted electromagnetic waves, and the transmittance with respect to the electromagnetic waves is high.

For example, in a case where the metasurface structure is a sheet type lens (convex lens), for example, the arrangement density of the metal microstructures decreases from the center toward the peripheral portion such that the phase difference to be imparted to the transmitted electromagnetic waves decreases from the center toward the peripheral portion.

Alternatively, in a case where the metasurface structure is a transmissive refraction plate, for example, the size of the metal microstructures increases such that the phase difference to be imparted to the transmitted electromagnetic waves increases from one end part toward another end part. Here, in a case where the transmissive refraction plate is configured by repeating the above-described units, for example, the size of the metal microstructures configuring the unit cell may be set to be large such that the phase difference to be imparted to the transmitted electromagnetic waves in the arrangement direction of the unit cells in the unit. In the transmissive refraction plate, the direction in which the phase difference to be imparted to the electromagnetic waves increases is a direction in which the electromagnetic waves are refracted.

In the sheet type lens and the transmissive refraction plate described above, a change in phase difference is not limited to being linear and may be nonlinear. That is, in the sheet type lens, as long as the phase difference to be imparted to the electromagnetic waves decreases from the center toward the peripheral portion as a whole, the decrease in phase difference may be linear or nonlinear. In addition, in a transmissive polarizing plate, as long as the phase difference to be imparted to the electromagnetic waves increases as a whole in the direction in which the electromagnetic waves are refracted, the increase in phase difference may be linear or nonlinear. Regarding this point, the same also applies to the above-described unit.

Regarding these designs, for example, the amplitude and the phase of electromagnetic waves transmitted through the metal microstructures to be used may be calculated using commercially available simulation software, and the arrangement of the metal microstructures may be set to obtain a desired distribution of phase difference (phase modulation amount (refractive index)).

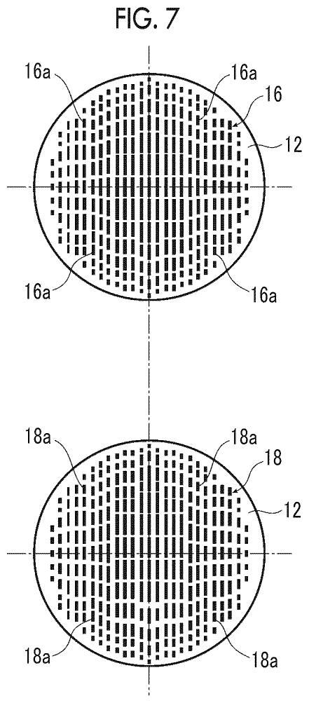

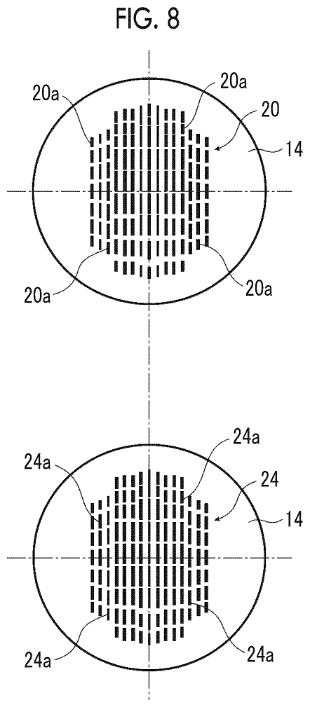

FIGS. 7 and 8 conceptually show an example where the metasurface structure according to the embodiment of the present invention is a sheet type condenser lens.

In the present example, the upper stage of FIG. 7 shows the first structure layer 16, and the lower stage of FIG. 7 shows the second structure layer 18. In addition, the upper stage of FIG. 8 shows the third structure layer 20, and the lower stage shows the fourth structure layer 24.

As described above, the metasurface structure is a sheet type condenser lens. Accordingly, the arrangement of the metal microstructures is set such that the phase difference of the transmitted electromagnetic waves, that is, the phase modulation amount gradually decreases from the center toward the peripheral portion.

In addition, in order to achieve the configuration, in the condenser lens shown in FIGS. 7 and 8, in the center portion and the vicinity of the center portion, the positions of the first metal microstructures 16a to the fourth metal microstructures 24a are shifted from the metal microstructure of another structure layer in the in-plane direction such that the transmitted electromagnetic waves can obtain a large phase difference.

In addition, in the center portion and the peripheral portion around the center portion, the amount of shift of the metal microstructures is reduced such that the phase difference of the transmitted electromagnetic waves is reduced as compared to the center portion.

Further, by not providing the metal microstructures in the third structure layer 20 and the fourth structure layer 24, the phase difference of the electromagnetic waves transmitted through the peripheral portion of the metasurface structure, that is, the sheet type lens is further reduced.

Hereinabove, the metasurface structure according to the embodiment of the present invention has been described above. However, the present invention is not limited to the above-described examples, and various improvements and modifications can be made within a range not departing from the scope of the present invention.

### EXAMPLES

Hereinafter, the characteristics of the present invention will be described in detail using examples.

It should be noted that the following examples are examples of the present invention. Accordingly, the present invention is not limited to the following specific examples.

In Examples and Comparative Example below, all of the metal microstructures (metal cut wires) were provided such that longitudinal directions thereof matched with each other.

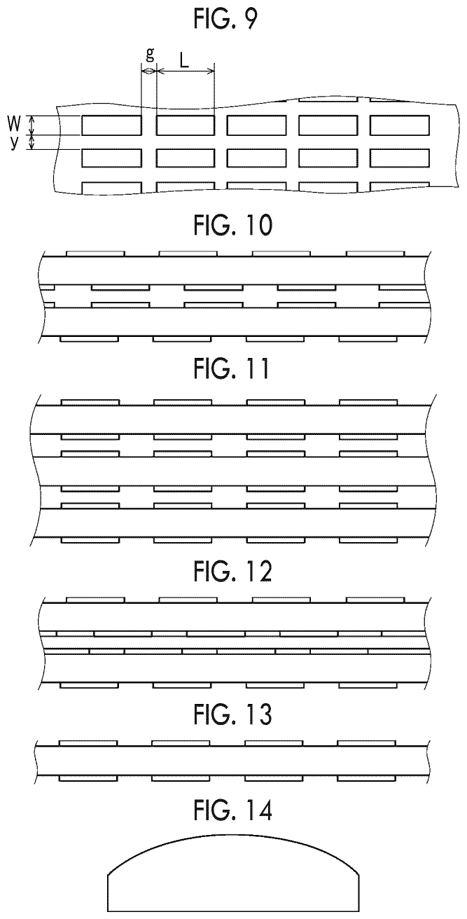

In addition, as conceptually shown in FIG. 9, in each of the structure layers, the metal microstructures were provided to be regularly arranged in the in-plane direction in a lattice form in two directions orthogonal to each other. The length of the metal microstructures is represented by L, the width of the metal microstructures is represented by W, the interval of the metal microstructures in the longitudinal direction is represented by g, and the interval of the metal microstructures in the width direction is represented by y.

In Examples 1 to 8 and Comparative Example 1, in a case where the metasurface structure included a plurality of structure layers, the lengths L, the widths W, the intervals g, and the intervals y of the metal microstructures in all of the structure layers were the same. That is, in Examples 1 to 8 and Comparative Example 1, in a case where the metasurface structure included a plurality of structure layers, the same metal microstructures were arranged in the same manner in the in-plane direction in all of the structure layers.

Further, the amount of shift between the first metal microstructures and the second metal microstructures and the amount of shift between the third metal microstructures and the fourth metal microstructures are represented by a. The amount of shift between the second metal microstructures 18a and the third metal microstructures 20a is represented by b.

Further, the interval between the first substrate 12 and the second substrate 14 is represented by d (hereinabove, refer to FIG. 6).

### Example 1

As the first substrate and the second substrate, a cycloolefin polymer film (thickness: 40 μm) was prepared.

The first substrate was cut into a size of 10×10 cm, and the surface was cleaned with ultrasonic waves (45 kHz). Thereafter, the cut first substrate was placed inside a sputtering apparatus. After reducing a pressure inside the apparatus, argon gas (0.27 Pa) was introduced, and sputtering was performed on a target using copper. The sputtering was performed in order on one surface of the first substrate, and a copper layer having a thickness of 100 nm was formed on both surfaces of the first substrate.

A photosensitive transfer member (negative transfer material 1) described in JP2020-204757A was cut into a size of 9×9 cm, and the cover film was peeled off from the photosensitive transfer material. The first substrate and the photosensitive transfer material were bonded to each other such that the surface of the photosensitive resin layer exposed by the peeling of the cover film was in contact with the copper layer. The photosensitive transfer material was bonded to both surfaces of the first substrate one by one, and a laminate was obtained. This bonding was performed under conditions of a roll temperature of 100° C., a linear pressure of 1.0 MPa, and a linear speed of 4.0 m/min.

Next, a photo mask in which a pattern complementary to the metal microstructures (metal cut wires) was formed was laminated on each of both surfaces of the obtained laminate on a temporary support side of the photosensitive transfer material. Thereafter, through the photo mask, the photosensitive resin layer of the photosensitive transfer material was irradiated and exposed with light from an ultra-high pressure mercury lamp (MAP-1200L, manufactured by Japan Science Engineering Co., Ltd., exposure main wavelength: 365 nm) at 100 mJ/cm².

The patterns of the photo mask on both of the surfaces of the first substrate were different from each other, the pattern of one surface was a design corresponding to the arrangement of the metal microstructures in the first structure layer described below, and the pattern of the other surface was a design corresponding to the pattern of the second structure layer described below.

The temporary supports of the photosensitive transfer material on both of the surfaces were peeled off from the exposed laminate. Next, shower development was performed on the laminate for 30 seconds using 1.0 mass % of a sodium carbonate aqueous solution having a liquid temperature of 25° C. to form a resist pattern on the copper layers of both of the surfaces.

Next, the copper layer of the obtained laminate was etched at 23° C. for 30 seconds using a copper etchant (Cu-02, manufactured by Kanto Chemical Co., Inc.). Further, the resist pattern was peeled off using propylene glycol monomethyl ether acetate.

As described above, a first structure layer where first metal microstructures (metal cut wires) having a length L of 0.36 mm and a width W of 0.05 mm were arranged in a lattice form (refer to FIG. 9) at the interval g of 0.03 mm in the length direction and the interval y of 0.09 mm in the width direction was formed on one surface of the first substrate. As described above, the thickness of the copper layer was 100 nm, and thus the thickness of the first metal microstructures was 100 nm.

In addition, a second structure layer where second metal microstructures were arranged in the same manner on the other surface of the first substrate was formed. Note that the second structure layer was formed such that the amount of shift a between the first metal microstructures and the second metal microstructures was 0.11 mm.

Further, a third structure layer and a fourth structure layer were formed on the second substrate using the completely the same method as that of the first structure layer and the second structure layer.

A cycloolefin polymer film having a thickness of 40 μm (d=0.04 mm) as a dielectric layer was bonded to the second structure layer formed on the first substrate, the third structure layer formed on the second substrate was bonded such that the amount of shift b between the second metal microstructures 18a and the third metal microstructures 20a was 0.07 mm, and end parts thereof were fixed.

As a result, as shown in FIG. 1, a metasurface structure including fourth structure layers of the first structure layer to the fourth structure layer was prepared.

### Example 2

A first substrate and a second substrate consisting of the same cycloolefin polymer film as that of Example 1 were prepared.

As in Example 1, a copper layer having a thickness of 100 nm was formed on both surfaces of the first substrate.

Next, the laminate was immersed in an acidic degreasing agent (ATS PURE CLEAN N3, manufactured by OKUNO CHEMICAL INDUSTRIES CO., LTD.) at a liquid temperature of 45° C. for 5 minutes to perform an acidic degreasing treatment thereon. Further, the laminate was immersed in 10% sulfuric acid at room temperature for 3 minutes, and an acid activation treatment was performed thereon.

Next, a photosensitive transfer member (negative transfer material 1) described in JP2020-204757A was cut into a size of 10×10 cm, and the cover film was peeled off from the photosensitive transfer material. The first substrate and the photosensitive transfer member were bonded to each other such that the surface of the photosensitive resin layer exposed by the peeling of the cover film was in contact with the copper layer. The bonding was performed on the copper layer of the single surface.

Next, the obtained laminate was immersed in a copper plating liquid (TOP LUCINA SF, manufactured by OKUNO CHEMICAL INDUSTRIES CO., LTD.), and a copper plating treatment was performed under a condition of 1 A/dm². The laminate after the copper plating treatment was cleaned with water and dried, and then immersed in a 1% by mass potassium hydroxide aqueous solution (pH=13.5) at 50° C.

Next, a temporary support of the photosensitive transfer member was peeled off, and then the photosensitive resin layer was peeled off using propylene glycol monomethyl ether acetate. As a result, a first substrate where the thickness of the copper layer on one side (the non-adhesive surface of the photosensitive transfer member) was increased to 500 nm was obtained.

The same copper plating treatment was performed on the other surface of the first substrate. As a result, the first substrate including the copper layer having a thickness of 500 nm on both of the surfaces was obtained.

Regarding the first substrate including the copper layer having a thickness of 500 nm on both of the surfaces, using the same method as that of Example 1, a first structure layer was formed on one surface, and a second structure layer was formed on the other surface.

Further, a third structure layer and a fourth structure layer were formed on the second substrate using the completely the same method as that of the first structure layer and the second structure layer.

That is, in the present example, the arrangement pattern of the metal microstructures in each of the structure layers was the same as that of Example 1, but the thickness of the metal microstructures (metal cut wires) was 100 nm in Example 1 and was 500 nm in the present example (Example 2).

### Example 3

A metasurface structure was prepared using the same method as that of Example 2, except that the thickness of the cycloolefin polymer film as the dielectric layer was changed to 460 μm (d=0.46 mm).

### Example 4

A first structure layer to a fourth structure layer were formed using the same method as that of Example 2, except that the length L of the metal microstructures was changed to 0.41 mm, the interval g was changed to 0.06 mm, and the amount of shift a between the first metal microstructure and the second metal microstructure and between the third metal microstructure and the fourth metal microstructure was changed to 0.22 mm.

In addition, the center of the cycloolefin polymer film (thickness: 20 μm (d=0.02 mm)) was cut out with a size of 20×20 mm to form a through-hole.

The first substrate and the second substrate were laminated such that the cycloolefin polymer film was interposed therebetween and the second metal microstructures and the third metal microstructures faced each other. Accordingly, in the present example, an air layer was provided between the second structure layer and the third structure layer. The lamination was performed such that the amount of shift b between the second metal microstructures and the third metal microstructures was 0.23 mm.

As a result, as shown in FIG. 2, a metasurface structure including fourth structure layers of the first structure layer to the fourth structure layer was prepared.

### Example 5

A first structure layer to a fourth structure layer were formed using the same method as that of Example 2, except that the length L of the metal microstructures was changed to 0.4 mm, the interval g was changed to 0.02 mm, and the amount of shift a between the first metal microstructure and the second metal microstructure and between the third metal microstructure and the fourth metal microstructure was changed to 0.28 mm.

In addition, the center of the cycloolefin polymer film was cut out with a size of 20×20 mm to form a through-hole. In the present example, the thickness of the cycloolefin polymer film was 100 μm (d=0.1 mm).

The first substrate and the second substrate were laminated such that the cycloolefin polymer film was interposed therebetween and the second metal microstructures and the third metal microstructures faced each other. Accordingly, even in the present example, an air layer was provided between the second structure layer and the third structure layer. The lamination was performed such that the amount of shift b between the second metal microstructures and the third metal microstructures was 0 mm.

As a result, as conceptually shown in FIG. 10, a metasurface structure including fourth structure layers of the first structure layer to the fourth structure layer was prepared.

### Example 6

A metasurface structure was prepared using the same method as that of Example 5, except that the thickness of the cycloolefin polymer film provided between the first substrate and the second substrate was changed to 600 μm (d=0.6 mm).

### Example 7

A first structure layer and a second structure layer were formed using the same method as that of Example 2, except that the length L of the metal microstructures was changed to 0.28 mm, the interval g was changed to 0.01 mm, and the amount of shift a between the first metal microstructure and the second metal microstructure was changed to 0 mm.

In addition, a third structure layer and a fourth structure layer were formed on the second substrate using the same method as that of the first structure layer and the second structure layer.

Further, the same third substrate was prepared, and a fifth structure layer and a sixth structure layer were formed on the third substrate using the same method as that of the first structure layer and the second structure layer.

A cycloolefin polymer film having a thickness of 40 μm (d=0.04 mm) as a dielectric layer was bonded to the second structure layer formed on the first substrate, the third structure layer formed on the second substrate was bonded such that the amount of shift b between the second metal microstructures 18a and the third metal microstructures 20a was 0 mm, and end parts thereof were fixed.

Further, a cycloolefin polymer film having a thickness of 40 μm (d=0.04 mm) as a dielectric layer was bonded to the fourth structure layer formed on the second substrate, the fifth structure layer formed on the third substrate was bonded such that the amount of shift b between the third metal microstructures and the metal microstructures of the third substrate was 0 mm, and end parts thereof were fixed.

As a result, as conceptually shown in FIG. 11, a metasurface structure including six structure layers of the first structure layer to the sixth structure layer was prepared.

### Example 8

A first structure layer was formed on one surface of the first substrate using the same method as that of Example 2.

In addition, a fourth structure layer was formed on one surface of the second substrate using the same method as that of Example 2.

Further, as a third substrate, a cycloolefin polymer film having a thickness of 40 μm was prepared, a second structure layer was formed on one surface of the third substrate using the same method as that of Example 2, and a third structure layer was formed on the other surface of the third substrate using the same method as that of Example 2. Note that the second structure layer and the third structure layer were formed such that the amount of shift b between the second metal microstructures and the third metal microstructures was 0.07 mm.

The surface of the first substrate opposite to the first structure layer and the second structure layer of the third substrate were laminated to face each other, the surface of the second substrate opposite to the fourth structure layer and the third structure layer of the third substrate were laminated to face each other, and end parts thereof were fixed. Note that the lamination was performed such that the amount of shift a between the first metal microstructures and the second metal microstructures and the amount of shift a between the third metal microstructures and the fourth metal microstructures were 0.11 mm.

As a result, as conceptually shown in FIG. 12, a metasurface structure including fourth structure layers of the first structure layer to the fourth structure layer was prepared.

### Comparative Example 1

As a substrate, a cycloolefin polymer film having a thickness of 44 μm was prepared.

Using the same method as that of Example 2, a first structure layer where first metal microstructures (metal cut wires) having a length L of 0.1275 mm and a width W of 0.024 mm were arranged in a lattice form (refer to FIG. 9) at the interval g of 0.024 mm in the length direction and the interval y of 0.22 mm in the width direction was formed on one surface of the cycloolefin polymer film.

In addition, a second structure layer where second metal microstructures that were the same as the first metal microstructures were arranged was formed on the other surface of the cycloolefin polymer film. Note that the amount of shift a between the first metal microstructures and the second metal microstructures was 0 mm.

As a result, as conceptually shown in FIG. 13, a metasurface structure including two structure layers of the first structure layer and the second structure layer was prepared.

### Comparative Example 2

An optical lens formed of polytetrafluoroethylene conceptually shown in FIG. 14 was used.

### [Evaluation]

Using a numerical simulation modeling terahertz time-domain spectroscopy (THz-TDS), a transmittance and a transmission phase difference with respect to electromagnetic waves having a frequency of 300 GHz (wavelength of 999 μm) were evaluated.

For example, the phase difference was evaluated based on 360° as a standard, a case where the phase difference with respect to the transmitted electromagnetic waves exceeded 360° was evaluated as A, and a case where the phase difference with respect to the transmitted electromagnetic waves was 360° or less was evaluated as B.

In addition, the transmittance was evaluated based on a transmittance at which a phase lag of 370° with respect to a vacuum was obtained. In the evaluation of the transmittance, for example, based on transmittances of 70% and 50% as evaluation standards, a transmittance of 70% or more was evaluated as A, a transmittance of 50% or more and less than 70% was evaluated as B, and a transmittance of less than 50% was evaluated as C.

The results are shown in the following table. In addition, the table also shows the thickness of the metasurface structure (optical lens).

TABLE 1
The thickness of the metal microstructures (metal cut wires) is 100 nm in
Example 1 and is 500 nm in the other cases

| | | Material | | | | | | | | | | |
|---|---|---|---|---|---|---|---|---|---|---|---|---|
| | Number | between | | | | | | | | | | |
| | of | Layers of | Dimensions [mm] | | | | | | | Thickness | Phase | |
| | Layers | Substrates | L | g | a | b | d | W | y | [μm] | Difference | Transmittance |
| Example 1 | 4 | Dielectric | 0.36 | 0.03 | 0.11 | 0.07 | 0.04 | 0.05 | 0.09 | 120 | A | B |
| Example 2 | 4 | Dielectric | 0.36 | 0.03 | 0.11 | 0.07 | 0.04 | 0.05 | 0.09 | 120 | A | A |
| Example 3 | 4 | Dielectric | 0.36 | 0.03 | 0.11 | 0.07 | 0.46 | 0.05 | 0.09 | 540 | A | A |
| Example 4 | 4 | Air | 0.41 | 0.06 | 0.22 | 0.23 | 0.02 | 0.05 | 0.09 | 100 | A | B |
| Example 5 | 4 | Air | 0.4 | 0.02 | 0.28 | 0 | 0.1 | 0.05 | 0.09 | 180 | A | B |
| Example 6 | 4 | Air | 0.4 | 0.02 | 0.28 | 0 | 0.6 | 0.05 | 0.09 | 680 | A | B |
| Example 7 | 6 | Dielectric | 0.28 | 0.01 | 0 | 0 | 0.04 | 0.05 | 0.09 | 200 | A | A |
| Example 8 | 4 | Dielectric | 0.36 | 0.03 | 0.11 | 0.07 | 0.04 | 0.05 | 0.09 | 120 | A | A |
| Comparative | 2 | Dielectric | 0.128 | 0.003 | 0 | — | — | 0.024 | 0.22 | 44 | B | — |
| Example 1 | | | | | | | | | | | | |
| Comparative | — | — | — | — | — | — | — | — | — | 4300 | A | A |
| Example 2 | | | | | | | | | | | | |

In Comparative Example 1, the evaluation result of the phase difference was B, and the phase difference (phase lag) was 360° or less. Therefore, the evaluation of the transmittance for the present example was not able to be performed.

As shown in the table above, with the metasurface structure according to the embodiment of the present invention, a phase difference exceeding 360° as the standard in the present example can be imparted to the transmitted electromagnetic waves, and the transmittance with respect to the electromagnetic waves is also high. In particular, it was found from a comparison between Examples 4 to 6 and Examples 2, 3, and 8 that a more suitable transmittance can be obtained by providing the dielectric layer between the first substrate and the second substrate and spacing the second structure layer and the third structure layer from each other.

In addition, it was found from a comparison between Examples 1 and 2 that a more suitable transmittance can be obtained by adjusting the thickness of the metal cut wires to be 500 nm or more.

Further, the metasurface structure according to the embodiment of the present invention is much thinner than the optical lens having the same performance.

### Example 9

Using the metasurface structure according to the embodiment of the present invention, a transmissive refraction plate was prepared.

Regarding the first structure layer to the fourth structure layer configuring the transmissive refraction plate, a basic configuration of each of the structure layers was as follows.

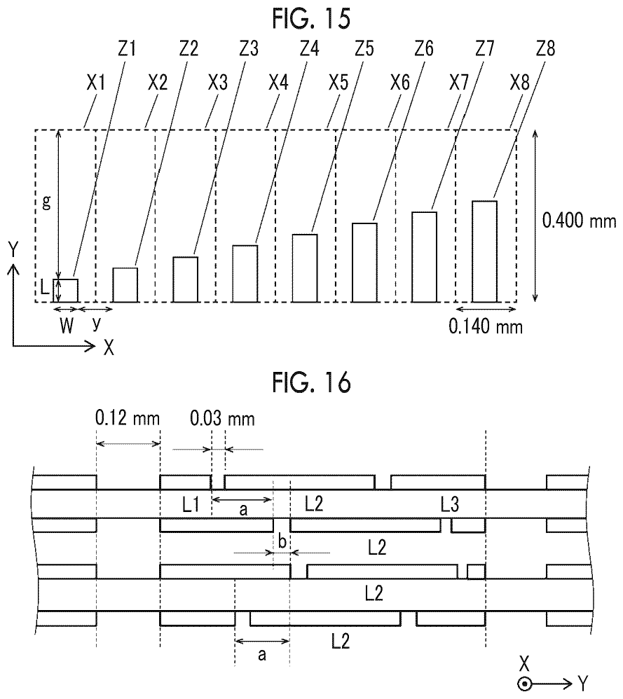

As conceptually shown in FIG. 15, a rectangular section having a length (Y direction) of 0.400 mm and a width (X direction) of 0.140 mm was set as a unit cell X. One unit was configured by arranging the eight unit cells X in the width direction (X direction).

In each of the unit cells X, metal microstructures Z (Z1 to Z8) were disposed such that they were aligned with the center of the rectangular section in the X direction and one edge surfaces of the metal microstructures were aligned with one edge surfaces of the unit cells X in the Y direction.

The metal microstructures Z was disposed on the unit cell X1, the metal microstructure Z2 was disposed on the unit cell X2, . . . , the metal microstructure Z7 was disposed on the unit cell X7, and the metal microstructure Z8 was disposed on the unit cell X8. As all of the microstructures, metal cut wires were used. The metal microstructures will be described below.

The units each of which consisted of the eight unit cells X1 to X8 were two-dimensionally regularly arranged in a rectangular lattice form in the X direction and the Y direction orthogonal to each other to configure each of the structure layers. Accordingly, in each of the structure layers, the unit cells X1 to X8 (the metal microstructures Z1 to Z8) were repeatedly disposed in the X direction, and the unit cells (metal microstructures Z) were arranged in the Y direction.

As illustrated in FIGS. 6, 9, and 15, the photo mask design was changed such that the length L and the width W of the metal microstructures Z1 to Z8, the interval g in the length direction and the interval y in the width direction of the metal microstructures, the amount of shift a between the first metal microstructures and the second metal microstructures and between the third metal microstructures and the fourth metal microstructures, and the amount of shift b between the second metal microstructures and the third metal microstructures were values shown in Table 2 below, respectively.

Using the same method as that of Example 2 except that the photo mask having the changed photo mask design was used, the first structure layer was formed on one surface of the first substrate, the second structure layer was formed on the other surface of the first substrate, the third structure layer was formed on one surface of the second substrate, the fourth structure layer was formed on the other surface of the second substrate, and a transmissive refraction plate 1 including fourth structure layers of the first structure layer to the fourth structure layer was prepared.

Accordingly, all of the thicknesses of the metal microstructures were 100 nm.

As described above, in the prepared metasurface structure, that is, the transmissive refraction plate, each of the first structure layer to the fourth structure layer was obtained by regularly two-dimensionally arranging the units in a rectangular lattice form in the X direction and the Y direction, each of the units being obtained by arranging the eight unit cells X1 to X8 including the metal microstructures Z1 to Z8 in the X direction, that is, in the width direction of the metal microstructures.

In the transmissive refraction plate 1 where the first structure layer to the fourth structure layer were laminated, regarding the unit cells X1 to X8 configuring the unit, a transmittance and a transmission phase difference of electromagnetic waves having a frequency of 300 GHz (wavelength: 999 μm) were measured using a numerical simulation modeling terahertz time-domain spectroscopy (THz-TDS). The transmittance and the transmission phase difference were the measurement results in a state where the four layers were laminated.

In addition, the transmission phase difference is specifically a phase difference imparted to the transmitted electromagnetic waves by the unit cells.

The results are also shown in Table 2.

TABLE 2

| | | | | | | | | | Phase | |
|---|---|---|---|---|---|---|---|---|---|---|
| Unit | | Dimensions [mm] | | | | | | | Difference | |
| Cell | Structure | L | g | a | b | d | W | y | [°] | Transmittance |
| X1 | Z1 | 0.200 | 0.200 | 0.000 | 0.000 | 0.040 | 0.084 | 0.056 | 66 | 80% |
| X2 | Z2 | 0.240 | 0.160 | 0.000 | 0.000 | 0.040 | 0.084 | 0.056 | 106 | 97% |
| X3 | Z3 | 0.270 | 0.130 | 0.000 | 0.000 | 0.040 | 0.084 | 0.056 | 163 | 66% |
| X4 | Z4 | 0.285 | 0.115 | 0.100 | 0.180 | 0.040 | 0.084 | 0.056 | 200 | 66% |
| X5 | Z5 | 0.310 | 0.090 | 0.080 | 0.160 | 0.040 | 0.084 | 0.056 | 253 | 82% |
| X6 | Z6 | 0.325 | 0.075 | 0.100 | 0.180 | 0.040 | 0.084 | 0.056 | 286 | 86% |
| X7 | Z7 | 0.350 | 0.050 | 0.140 | 0.180 | 0.040 | 0.084 | 0.056 | 322 | 82% |
| X8 | Z8 | 0.365 | 0.035 | 0.120 | 0.080 | 0.040 | 0.084 | 0.056 | 377 | 59% |

In Comparative Example, a transmissive refraction plate consisting of only the first substrate according to Example 9, that is, a transmissive refraction plate consisting of only the two structure layers of the first structure layer and the second structure layer was prepared, and a transmission phase difference was measured using the same measured.

As a result, in Comparative Example, phase differences of all the unit cells were smaller than that of Example 9.

### Example 10

As illustrated in FIGS. 6, 9, and 15, the photo mask design was changed such that the length L and the width W of the metal microstructures Z1 to Z8, the interval g in the length direction and the interval y in the width direction of the metal microstructures, the amount of shift a between the first metal microstructures and the second metal microstructures and between the third metal microstructures and the fourth metal microstructures, and the amount of shift b between the second metal microstructures and the third metal microstructures were values shown in Table 3 below, respectively.

Using the same method as that of Example 9, that is, Example 2 except that the photo mask having the changed photo mask design was used, the first structure layer was formed on one surface of the first substrate, the second structure layer was formed on the other surface of the first substrate, the third structure layer was formed on one surface of the second substrate, the fourth structure layer was formed on the other surface of the second substrate, and a transmissive refraction plate 2 including fourth structure layers of the first structure layer to the fourth structure layer was prepared.

In the transmissive refraction plate 2 where the first structure layer to the fourth structure layer were laminated, regarding the unit cells X1 to X8 configuring the unit, a transmittance and a transmission phase difference of electromagnetic waves having a frequency of 300 GHz (wavelength: 999 μm) were measured using the same method as that of Example 9. The results are also shown in Table 3.

TABLE 3

| | | | | | | | | | Phase | |
|---|---|---|---|---|---|---|---|---|---|---|
| Unit | | Dimensions [mm] | | | | | | | Difference | |
| Cell | Structure | L | g | a | b | d | W | y | [°] | Transmittance |
| X1 | Z1 | 0.217 | 0.183 | 0.000 | 0.000 | 0.040 | 0.084 | 0.056 | 79 | 87% |
| X2 | Z2 | 0.251 | 0.149 | 0.000 | 0.000 | 0.040 | 0.084 | 0.056 | 125 | 93% |
| X3 | Z3 | 0.239 | 0.161 | 0.000 | 0.000 | 0.040 | 0.084 | 0.056 | 105 | 97% |
| X4 | Z4 | 0.249 | 0.151 | 0.104 | 0.172 | 0.040 | 0.084 | 0.056 | 129 | 88% |
| X5 | Z5 | 0.298 | 0.102 | 0.079 | 0.162 | 0.040 | 0.084 | 0.056 | 217 | 78% |
| X6 | Z6 | 0.325 | 0.075 | 0.104 | 0.180 | 0.040 | 0.084 | 0.056 | 280 | 82% |
| X7 | Z7 | 0.324 | 0.076 | 0.129 | 0.180 | 0.040 | 0.084 | 0.056 | 251 | 35% |
| X8 | Z8 | 0.352 | 0.048 | 0.122 | 0.079 | 0.040 | 0.084 | 0.056 | 282 | 41% |

In Comparative Example, a transmissive refraction plate consisting of only the first substrate according to Example 10, that is, a transmissive refraction plate consisting of only the two structure layers of the first structure layer and the second structure layer was prepared, and a transmission phase difference was measured using the same measured.

As a result, in Comparative Example, phase differences of all the unit cells were smaller than that of Example 10.

### [Measurement of Refraction of Electromagnetic Waves]

Using the following method, transmitted and refracted waves of the prepared transmissive refraction plates 1 and 2 were measured.

An optical system was constructed by connecting a generator (a terahertz generation module (TAS1120, manufactured by Advantest Corporation)) and a detector (a terahertz detection module (TAS1230, manufactured by Advantest Corporation) to a laser output port of a terahertz optical sampling analysis system (TAS7400TS, manufactured by Advantest Corporation).

In this optical system, polarized waves parallel to the longitudinal direction of the metal microstructures (metal cut wires) are incident from the normal direction of the transmissive refraction plate using the generator, electromagnetic waves refracted in the width direction of the metal microstructures were detected using the detector, and the intensity of the refracted waves was measured. In addition, in a state where the transmissive refraction plate was removed, a transmitted wave intensity measured by making the generator and the detector in transmission geometry, and the intensity of the refracted waves with respect to the intensity was obtained as diffraction efficiency.

As a result, at 300 GHz, in the transmissive refraction plate 1, the intensity measured at a position where the detector was inclined at 63° with respect to the incident waves was the maximum, and the diffraction efficiency was 45%. In addition, in the transmissive refraction plate 2, the intensity measured at a position where the detector was inclined at 63° with respect to the incident waves was the maximum, and the diffraction efficiency was 70%.

As described above, in the transmissive refraction plate consisting of the metasurface structure according to the embodiment of the present invention, the incident electromagnetic waves were largely refracted due to a large phase distribution formed by the four structure layers configuring the metasurface structure.

In addition, the transmissive refraction plates according to Example 9 and Example 10 are metasurface structures including the fourth structure layers of the first structure layer to the fourth structure layer where the units each of which consists of the unit cells X1 to X8 including the metal microstructures Z1 to Z8 are regularly two-dimensionally arranged in a rectangular lattice form in the X direction and the Y direction orthogonal to each other.

As shown in Tables 2 and 3, in Example 9 and Example 10, the phase difference of the unit cells in the unit increased from the unit cell X1 toward the unit cell X8. However, in Example 9, the phase difference of the unit cells in the unit increased linearly, that is, gradually from the unit cell X1 toward the unit cell X8. On the other hand, in Example 10, the phase difference of the unit cells in the unit decreased from the unit cell X1 toward the unit cell X8 in some portions, and that is, a change in the phase difference of the unit cells was nonlinear. It was found from a comparison between Example 9 and Example 10 that, in the transmissive refraction plate consisting of the metasurface structure, in a case where the phase difference of the unit cells configuring the unit changes nonlinearly, the diffraction efficiency is higher than that in a case where the phase difference changes linearly.

### Example 11

Using the metasurface structure according to the embodiment of the present invention, a sheet type lens was prepared.

As in the above-described example, the first structure layer was formed on one surface of the first substrate, the second structure layer was formed on the other surface of the first substrate, the third structure layer was formed on one surface of the second substrate, the fourth structure layer was formed on the other surface of the second substrate, and the first substrate and the second substrate were combined to prepare a sheet type lens.

Each of the structure layers was configured by arranging two types of units of a first unit and a second unit.

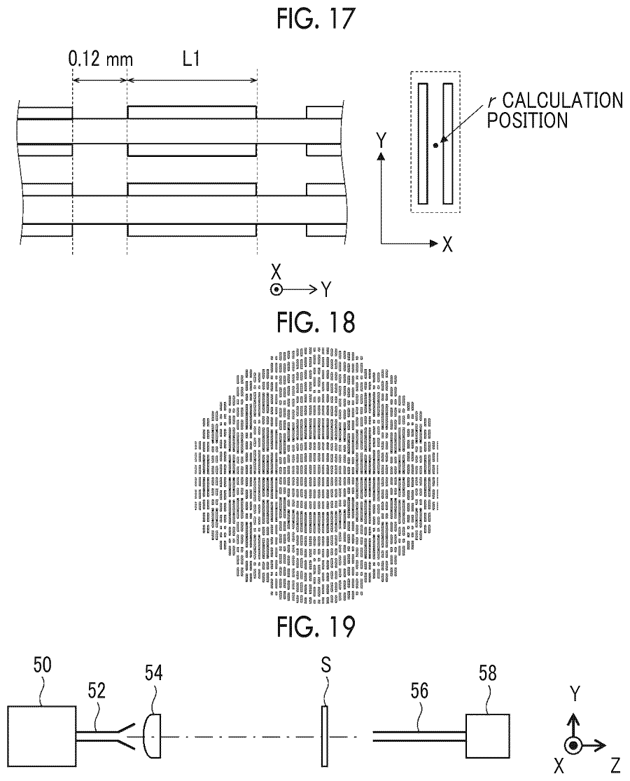

As conceptually shown in FIG. 16, the first unit was configured by six unit cells in total including three metal microstructures, that is, three unit cells in the Y direction (length direction) and two metal microstructures, that is, two unit cells (refer to FIG. 17) in the X direction (width direction).

On the other hand, as conceptually shown in FIG. 17, the second unit was configured by two unit cells in total including one metal microstructure, that is, one unit cell in the Y direction (length direction) and two metal microstructures, that is, two unit cells in the X direction (width direction).

In the present example, all of the metal microstructures were metal cut wires, in which the width W was 0.054 mm and the thickness was 100 nm.

In addition, in the present example, the intervals in the width direction (X direction) of the adjacent metal microstructures were all 0.086 mm as in the above-described example.

Further, in the present example, in both of the first unit and the second unit, the intervals in the longitudinal direction (Y direction) of the adjacent metal microstructures of the adjacent units were all 0.12 mm.

Regarding the above-described point the same applies to all of the metal microstructures and the units provided in the first to fourth structure layers.

The first unit is configured with a first metal microstructure having a length of L1, a second metal microstructure having a length of L2 that is disposed to be spaced from the first metal microstructure by 0.03 mm, and a third metal microstructure having a length of L3 that is disposed to be spaced from the second metal microstructure by 0.03 mm. As shown in FIG. 16, the spacing distance of the metal microstructures is the distance in the length direction.

The second unit is configured with the metal microstructure having the length L1.

In addition, as described above, in all of the units, an interval between the units adjacent to each other is 0.12 mm.

The unit to be used, that is, the first unit or the second unit was selected and the length L and the amount of shift (the amount of shift a and the amount of shift b) of the metal microstructures configuring the unit were selected such that a target phase difference amount φ (target phase difference q) defined by Expression x below was closest to a distance r between the center (optical axis) of the sheet type lens and a center position of the unit in a state where any integral multiple of 360° was allowed with respect to the target phase difference [°] shown in Table 4 below. As shown in FIG. 17, the center position of the unit, that is, the calculation position of the distance r (r calculation position) is a position at the center of the metal microstructures in each of the units in the length direction and at the center of two metal microstructures in the width direction.

In addition, in Table 4, the target phase difference refers to the total phase difference of the first structure layer to the fourth structure layer. In the present example, regarding both of the first unit and the second unit, all of the units that overlap each other in the thickness direction at the same position in the in-plane direction in the first structure layer to the fourth structure layer are considered as one unit, and the first unit and the second unit do not overlap each other in the thickness direction at the same position in the in-plane direction.

In Expression x below, Rmax represents the radius of the lens, f represents the focal length of the lens, and λ represents the wavelength of electromagnetic waves. In the present example, the radius Rmax of the lens was 4 mm, and the focal length f of the lens was 2.7 mm. Further, in the electromagnetic waves, the wavelength λ at a frequency of 300 GHz was 0.999 mm.

$$φ [ ° ] = [ ( R {max}^{2} - {r}^{2} ) / 2 f ] \times ( 360 ° / λ ) + 178 ° \qquad Expression x$$

In Table 4, the numerical values of L1 to L3 are numerical values of the first structure layer.

The lengths of the first to third metal microstructures configuring the first unit in the second to fourth structure layers are as follows.

That is, in the second to fourth structure layers, the first unit is as follows.

As shown in FIG. 16, in the second structure layer, one end part of the first metal microstructure is at the same position (no shift) as that of one end part of the first structure layer on the same side, and the length thereof is L1+the amount of shift a. The second metal microstructure is disposed to be spaced from the first metal microstructure by 0.03 mm, and the length thereof is L2. Further, the third metal microstructure is disposed to be spaced from the second metal microstructure by 0.03 mm, and the length thereof is L3—the amount of shift a.

In addition, as shown in FIG. 16, in the third structure layer, one end part of the first metal microstructure is at the same position (no shift) as that of one end part of the first structure layer on the same side, and the length thereof is L1+the amount of shift a+the amount of shift b. The second metal microstructure is disposed to be spaced from the first metal microstructure by 0.03 mm, and the length thereof is L2. The third metal microstructure is disposed to be spaced from the second metal microstructure by 0.03 mm, and the length thereof is L3—the amount of shift a—the amount of shift b.

Further, as shown in FIG. 16, in the fourth structure layer, one end part of the first metal microstructure is at the same position (no shift) as that of one end part of the first structure layer on the same side, and the length thereof is L1+the amount of shift b. The second metal microstructure is disposed to be spaced from the first metal microstructure by 0.03 mm, and the length thereof is L2. The third metal microstructure configuring the first unit is disposed to be spaced from the second metal microstructure by 0.03 mm, and the length thereof is L3—the amount of shift b.

Note that, in the first units of the second to fourth structure layers, in a case where the length of the third metal microstructure is negative, the third metal microstructure is not disposed.

On the other hand, in the first to fourth structure layers, all of the lengths of the metal microstructures in the second unit are L1 as shown in FIG. 17, and the amount of shift a=the amount of shift b=0.

TABLE 4

| | | | | | | | Phase |
|---|---|---|---|---|---|---|---|
| Target | | | | | | | Difference of |
| Phase | | Length of Metal | | | Amount of Shift [mm] | | Comparative |
| Difference | | Microstructures [mm] | | | Amount of | Amount of | Example |
| [°] | Unit | L1 | L2 | L3 | Shift a | Shift b | [°] |
| 40 | Second Unit | 0.1 | — | — | 0 | 0 | 20 |
| 50 | Second Unit | 0.14 | — | — | 0 | 0 | 27 |
| 58 | Second Unit | 0.17 | — | — | 0 | 0 | 32 |
| 69 | Second Unit | 0.2 | — | — | 0 | 0 | 37 |
| 74 | Second Unit | 0.21 | — | — | 0 | 0 | 39 |
| 80 | Second Unit | 0.22 | — | — | 0 | 0 | 41 |
| 88 | Second Unit | 0.23 | — | — | 0 | 0 | 43 |
| 98 | Second Unit | 0.24 | — | — | 0 | 0 | 46 |
| 110 | Second Unit | 0.25 | — | — | 0 | 0 | 48 |
| 125 | Second Unit | 0.26 | — | — | 0 | 0 | 50 |
| 143 | Second Unit | 0.27 | — | — | 0 | 0 | 54 |
| 163 | Second Unit | 0.28 | — | — | 0 | 0 | 57 |
| 188 | Second Unit | 0.29 | — | — | 0 | 0 | 63 |
| 233 | Second Unit | 0.3 | — | — | 0 | 0 | 72 |
| 249 | First Unit | 0.04 | 0.38 | 0.3 | 0.3 | 0 | 102 |
| 272 | First Unit | 0.04 | 0.4 | 0.32 | 0.35 | 0.05 | 112 |
| 283 | First Unit | 0.04 | 0.31 | 0.23 | 0.2 | 0.5 | 112 |
| 320 | First Unit | 0.04 | 0.305 | 0.225 | 0 | 0.1 | 75 |
| 328 | First Unit | 0.04 | 0.305 | 0.225 | 0 | 0.05 | 75 |
| 355 | First Unit | 0.04 | 0.33 | 0.25 | 0.15 | 0 | 89 |
| 384 | First Unit | 0.04 | 0.335 | 0.255 | 0.15 | 0.05 | 108 |

Each of the units was disposed such that the center position of the unit (“r calculation position” in FIG. 17) was at the position shown in Table 5.

Table 5 shows, at each of the positions of the structure layers, the distance r between the center (optical axis) of the sheet type lens and the center position of the unit, the phase difference amount [°] calculated by Expression x above, and the target phase difference [°] in Table 4 corresponding to the phase difference amount calculated by Expression x. Depending on the target phase difference of each of the positions shown in Table 5, the unit (the first unit or the second unit) to be disposed at each of the positions in the structure layer was selected, and the photo mask design was changed such that the metal microstructure (length) and the position (amount of shift) of the metal microstructure were configured as shown in Table 4.

In Table 5, x [mm] represents the position in the X direction from the center of the sheet type lens, and y [mm] represents the position in the Y direction from the center of the sheet type lens.

Using the same method as that of Example 2 except that the photo mask having the changed photo mask design was used, the first structure layer was formed on one surface of the first substrate, the second structure layer was formed on the other surface of the first substrate, the third structure layer was formed on one surface of the second substrate, the fourth structure layer was formed on the other surface of the second substrate, and a sheet type lens 1 including fourth structure layers of the first structure layer to the fourth structure layer was prepared.

FIG. 18 shows a schematic top view (first structure layer) of the prepared sheet type lens.

TABLE 5

| | | | Phase | |
|---|---|---|---|---|
| | | | Difference | Target |
| | | | Amount φ | Phase |
| | | | (Expression | Difference |
| x | y | r | x) | (Table 4] |
| [mm] | [mm] | [mm] | [°] | [°] |
| 0.20 | 0 | 0.20 | 163 | 163 |
| 0.60 | 0 | 0.60 | 142 | 143 |
| 0.97 | 0 | 0.97 | 103 | 98 |
| 1.55 | 0 | 1.55 | 5 | 355 |
| 2.16 | 0 | 2.16 | 216 | 188 |
| 2.51 | 0 | 2.51 | 107 | 58 |
| 2.76 | 0 | 2.76 | 17 | 40 |
| 3.08 | 0 | 3.08 | 253 | 233 |
| 3.45 | 0 | 3.45 | 91 | 69 |
| 3.82 | 0 | 3.82 | 272 | 233 |
| 4.16 | 0 | 4.16 | 91 | 50 |
| 0.20 | 0.28 | 0.34 | 158 | 163 |
| 0.60 | 0.28 | 0.66 | 137 | 143 |
| 0.97 | 0.28 | 1.01 | 98 | 98 |
| 1.55 | 0.28 | 1.58 | 0 | 355 |
| 2.16 | 0.28 | 2.17 | 211 | 188 |
| 2.54 | 0.28 | 2.56 | 90 | 98 |
| 2.9 | 0.28 | 2.94 | 308 | 233 |
| 3.33 | 0.28 | 3.34 | 141 | 125 |
| 3.73 | 0.28 | 3.74 | 312 | 233 |
| 4.12 | 0.28 | 4.12 | 110 | 88 |
| 0.20 | 0.56 | 0.59 | 142 | 143 |
| 0.58 | 0.56 | 0.81 | 122 | 125 |
| 0.95 | 0.56 | 1.10 | 85 | 88 |
| 1.52 | 0.56 | 1.62 | 351 | 355 |
| 2.13 | 0.56 | 2.20 | 203 | 188 |
| 2.50 | 0.56 | 2.56 | 89 | 74 |
| 2.87 | 0.56 | 2.92 | 315 | 233 |
| 3.27 | 0.56 | 3.32 | 151 | 125 |
| 3.67 | 0.56 | 3.71 | 326 | 233 |
| 4.06 | 0.56 | 4.09 | 128 | 88 |
| 0.19 | 0.84 | 0.86 | 116 | 125 |
| 0.56 | 0.84 | 1.01 | 98 | 98 |
| 0.90 | 0.84 | 1.23 | 65 | 69 |
| 1.44 | 0.84 | 1.66 | 341 | 328 |
| 2.02 | 0.84 | 2.18 | 208 | 188 |
| 2.4 | 0.84 | 2.54 | 96 | 88 |
| 2.7 | 0.84 | 2.90 | 323 | 233 |
| 3.19 | 0.84 | 3.29 | 162 | 143 |
| 3.59 | 0.84 | 3.69 | 339 | 233 |
| 3.9 | 0.84 | 4.07 | 139 | 110 |
| 0.17 | 1.12 | 1.13 | 80 | 80 |
| 0.50 | 1.12 | 1.23 | 65 | 69 |
| 1.06 | 1.12 | 1.54 | 7 | 355 |
| 1.67 | 1.12 | 2.01 | 256 | 233 |
| 2.08 | 1.12 | 2.36 | 155 | 143 |
| 2.40 | 1.12 | 2.65 | 58 | 50 |
| 2.7 | 1.12 | 2.96 | 301 | 233 |
| 3.14 | 1.12 | 3.33 | 144 | 125 |
| 3.54 | 1.12 | 3.71 | 326 | 233 |
| 3.93 | 1.12 | 4.09 | 131 | 98 |
| 0.41 | 1.4 | 1.46 | 24 | 384 |
| 1.19 | 1.4 | 1.84 | 300 | 283 |
| 1.78 | 1.4 | 2.26 | 185 | 188 |
| 2.1 | 1.4 | 2.56 | 89 | 69 |
| 2.51 | 1.4 | 2.87 | 335 | 233 |
| 2.92 | 1.4 | 3.24 | 186 | 163 |
| 3.23 | 1.4 | 3.52 | 59 | 40 |
| 3.55 | 1.4 | 3.82 | 274 | 233 |
| 3.76 | 1.4 | 4.01 | 171 | 40 |
| 0.38 | 1.68 | 1.72 | 328 | 328 |
| 1.20 | 1.68 | 2.06 | 241 | 249 |
| 1.84 | 1.68 | 2.49 | 113 | 110 |
| 2.4 | 1.68 | 2.93 | 313 | 283 |
| 2.9 | 1.68 | 3.40 | 113 | 98 |
| 3.35 | 1.68 | 3.75 | 308 | 233 |
| 0.45 | 1.96 | 2.01 | 256 | 249 |
| 1.11 | 1.96 | 2.25 | 188 | 188 |
| 1.50 | 1.96 | 2.47 | 120 | 110 |
| 1.79 | 1.96 | 2.65 | 56 | 40 |
| 2.35 | 1.96 | 3.06 | 261 | 249 |
| 2.91 | 1.96 | 3.51 | 64 | 40 |
| 3.23 | 1.96 | 3.78 | 293 | 233 |
| 0.21 | 2.24 | 2.25 | 188 | 188 |
| 0.61 | 2.24 | 2.32 | 166 | 163 |
| 1.00 | 2.24 | 2.45 | 125 | 110 |
| 1.33 | 2.24 | 2.60 | 74 | 58 |
| 1.94 | 2.24 | 2.96 | 300 | 272 |
| 2.58 | 2.24 | 3.41 | 108 | 74 |
| 2.95 | 2.24 | 3.70 | 330 | 233 |
| 3.35 | 2.24 | 4.03 | 162 | 125 |
| 0.18 | 2.52 | 2.53 | 100 | 88 |
| 0.52 | 2.52 | 2.57 | 84 | 74 |
| 1.08 | 2.52 | 2.74 | 24 | 355 |
| 1.69 | 2.52 | 3.03 | 271 | 233 |
| 2.10 | 2.52 | 3.28 | 169 | 143 |
| 2.42 | 2.52 | 3.49 | 71 | 50 |
| 2.76 | 2.52 | 3.74 | 314 | 233 |
| 3.16 | 2.52 | 4.04 | 156 | 125 |
| 0.38 | 2.8 | 2.83 | 353 | 328 |
| 1.20 | 2.8 | 3.05 | 266 | 249 |
| 1.84 | 2.8 | 3.35 | 137 | 125 |
| 2.14 | 2.8 | 3.52 | 57 | 40 |
| 2.46 | 2.8 | 3.73 | 319 | 233 |
| 0.21 | 3.08 | 3.09 | 250 | 233 |
| 0.63 | 3.08 | 3.14 | 226 | 233 |
| 1.04 | 3.08 | 3.25 | 180 | 163 |
| 1.42 | 3.08 | 3.39 | 118 | 98 |
| 2.00 | 3.08 | 3.67 | 346 | 40 |
| 2.80 | 3.08 | 4.16 | 89 | 50 |
| 3.40 | 3.08 | 4.59 | 201 | 163 |
| 0.19 | 3.36 | 3.37 | 130 | 110 |
| 0.55 | 3.36 | 3.40 | 113 | 88 |
| 0.87 | 3.36 | 3.47 | 82 | 58 |
| 1.39 | 3.36 | 3.63 | 4 | 328 |
| 1.97 | 3.36 | 3.89 | 235 | 188 |
| 0.38 | 3.64 | 3.66 | 352 | 320 |
| 0.96 | 3.64 | 3.76 | 300 | 233 |
| 1.38 | 3.64 | 3.89 | 235 | 188 |
| 1.77 | 3.64 | 4.05 | 154 | 110 |
| 0.21 | 3.92 | 3.93 | 217 | 188 |
| 0.61 | 3.92 | 3.97 | 195 | 163 |
| 1.00 | 3.92 | 4.04 | 154 | 110 |

### [Measurement of Electromagnetic Wave Focusing Ability]

Using the following method, an electromagnetic wave focusing ability of the prepared sheet type lens 1 was measured.

As shown in FIG. 19, terahertz waves of 300 GHz emitted from a wave source 50 were vertically incident on the sheet type lens 1 (reference numeral S) having an effective diameter of 8 mm (radius Rmax=4 mm) as a collimated beam (plane wave) in a free space by a horn antenna 52 and a resin lens 54. The polarization direction of the electromagnetic waves was parallel to the longitudinal direction of the metal cut wires used as the metal microstructures, that is, was the Y direction.

Next, the back surface side of the sheet type lens 1 was scanned with a WR3.4 metal waveguide probe 56 in the X-Y-Z directions. The intensity of the electromagnetic waves incident on the probe was detected by a Schottky diode 58, and the voltage value was obtained as the intensity at this point.

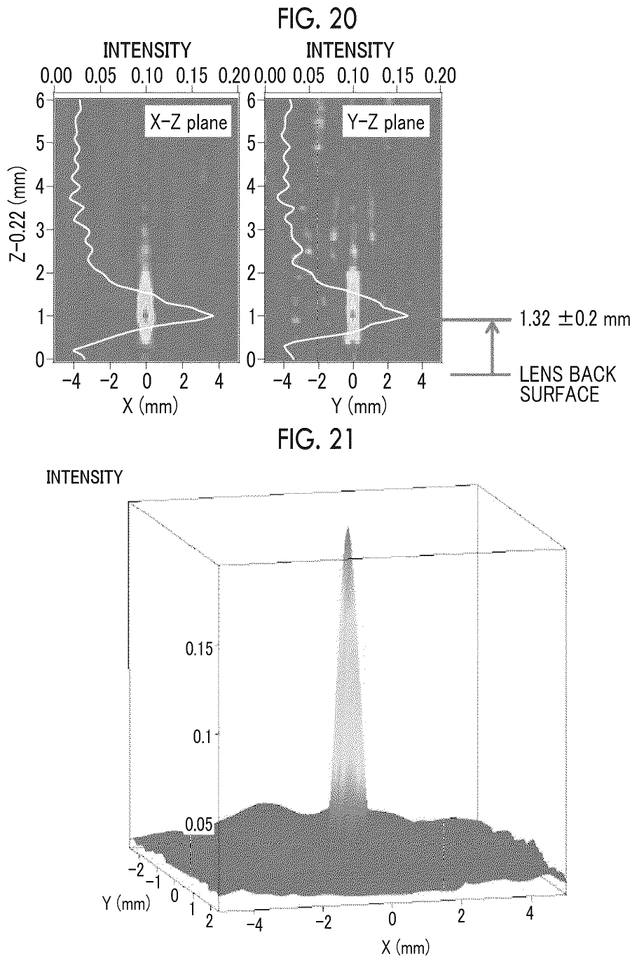

FIG. 20 shows an intensity distribution of the electromagnetic waves obtained on an X-Z plane and a Y-Z plane including the optical axis. In the present example, the electromagnetic wave intensity was the maximum at z=1.3 mm. In the present example, the back surface position of the lens corresponds to Z=0 mm, and an offset of 0.22 mm was present between the origin in the X-Y-Z directions and the position of the lens back surface.

In addition, FIG. 21 shows a field intensity distribution of an X-Y plane at Z=1.3 mm. The full width at half maximum of the focal point was 0.6 mm in the X direction and was 0.7 mm in the Y direction. The maximum field intensity increased to 17 times that in a case where the sheet type lens 1 was not provided, which shows that the sheet type lens 1 operated as a convex lens.

Further, using the following method, a directivity improving effect of the prepared sheet type lens 1 was measured.

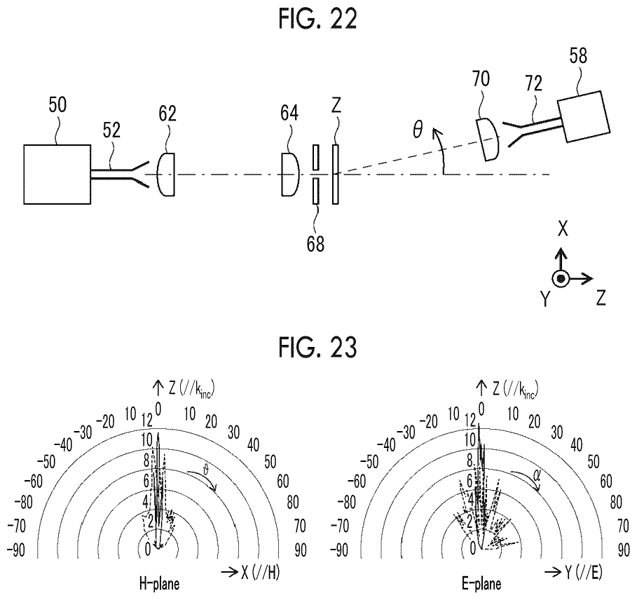

As shown in FIG. 22, terahertz waves of 300 GHz emitted from the wave source 50 were focused by the resin lens 54 and a resin lens 56 through the horn antenna 52, and were incident on a metal pinhole 68 having a diameter of 0.6 mm. The polarization direction of the electromagnetic waves was parallel to the longitudinal direction of the metal cut wires used as the metal microstructures, that is, was the Y direction.

The sheet type lens 1 (reference numeral S) was provided at a position of 1.3 mm from the pinhole 68, and a transmitted flux having a large divergence angle was collimated by the sheet type lens 1.

On a concentric circle around an incident surface of the sheet type lens 1, the detector directed to the rotation center was scanned in an angular direction to measure the directivity of the terahertz waves transmitted through the sheet type lens 1. Electromagnetic waves were focused by a resin lens 70 and a horn antenna 72 provided at a position of 20 cm from the sheet type lens 1, and the intensity of the electromagnetic waves was detected by the Schottky diode 58 as the detector.

FIG. 23 shows the scanning result of the detector after changing the angle as indicated by θ in the drawing in an H-plane (orthogonal to the polarized waves) and an E-plane (parallel to the polarized waves) including a terahertz wave optical axis. The divergence angle of the collimated beam was about 7° in both of the E-plane and the H-plane. The field intensity of the beam center in a case where the sheet type lens 1 was present (solid line) increased to 12 times that in a case where the sheet type lens 1 was not present, which shows that the directivity improving effect of the sheet type lens 1. In FIG. 23, the value in a case where the sheet type lens 1 was not present was increased to 10 times.

In Comparative Example, a sheet type lens 2 consisting of only the first substrate in the sheet type lens 1 prepared in Example 11, that is, the sheet type lens 2 consisting of two structure layers of the first structure layer and the second structure layer was prepared.

Regarding each of the units according to Comparative Example disposed at the same position as the unit having each of target phase differences shown in Table 4, as described above, the phase difference (transmission phase difference) of the electromagnetic waves having a frequency of 300 GHz (wavelength of 999 μm) was measured using a numerical simulation modeling terahertz time-domain spectroscopy (THz-TDS). In other words, the phase difference of the electromagnetic waves for the same unit as the unit according to Example 11 was measured using the same method as described above, except that the third structure layer and the fourth structure layer were not provided in each of the units according to Comparative Example.

The results are also shown in Table 4. As shown in Table 4, in Comparative Example, the phase differences of all the units were smaller than that of Example 11.

In addition, regarding the sheet type lens 2 according to Comparative Example, the beam focusing ability and the directivity improving effect were measured using the same method as that of the sheet type lens 1 according to Example 11. Regarding the beam focusing, since the phase difference amount was small, the focal point was not observed, and the operation as a convex lens was not observed. Likewise, regarding the directivity improving effect, the intensity decreased to 1 time or less that in a case where the sheet type lens 2 was not present, and the directivity improving effect was not observed.

The present invention can be suitably used for a communication system using terahertz waves.

### EXPLANATION OF REFERENCES

10: metasurface structure
12: first substrate
14: second substrate
16: first structure layer
16a: first metal microstructure
18: second structure layer
18a: second metal microstructure
20: third structure layer
20a: third metal microstructure
24: fourth structure layer
24a: fourth metal microstructure
26: dielectric layer
30: pillar
32: spacer
50: wave source
52: horn antenna
54, 62, 64, 70: resin lens
56: metal waveguide probe
58: Schottky diode
68: pinhole
S: sheet type lens

What is claimed is:

1. A metasurface structure that acts on electromagnetic waves having a frequency of 10 THz or less and is obtained by laminating a first structure layer, a second structure layer, a third structure layer, and a fourth structure layer to be spaced from each other,
the first structure layer being obtained by disposing a plurality of first metal microstructures in an in-plane direction,
the second structure layer being obtained by disposing a plurality of second metal microstructures in the in-plane direction,
the third structure layer being obtained by disposing a plurality of third metal microstructures in the in-plane direction, and
the fourth structure layer being obtained by disposing a plurality of fourth metal microstructures in the in-plane direction.

2. The metasurface structure according to claim 1,
wherein in at least one of the first structure layer, the second structure layer, the third structure layer, or the fourth structure layer, at least one metal microstructure is disposed to be shifted from the metal microstructure of another structure layer in the in-plane direction.

3. The metasurface structure according to claim 2,
wherein in all of the first structure layer, the second structure layer, the third structure layer, and the fourth structure layer, at least one metal microstructure is disposed to be shifted from the metal microstructure of another structure layer in the in-plane direction.

4. The metasurface structure according to claim 1, further comprising:
a dielectric layer that is provided in at least one of a position between the first structure layer and the second structure layer, a position between the second structure layer and the third structure layer, or a position between the third structure layer and the fourth structure layer.

5. The metasurface structure according to claim 1, further comprising:
a spacer that is provided in at least one of a position between the first structure layer and the second structure layer, a position between the second structure layer and the third structure layer, or a position between the third structure layer and the fourth structure layer.

6. The metasurface structure according to claim 1,
wherein in at least one of the first structure layer, the second structure layer, the third structure layer, or the fourth structure layer, at least one metal microstructure is a metal cut wire.

7. The metasurface structure according to claim 6,
wherein in all of the first structure layer, the second structure layer, the third structure layer, and the fourth structure layer, all of the metal microstructures are the metal cut wires.

8. The metasurface structure according to claim 6,
wherein a length of the metal cut wire is 0.1 to 1.0 time a wavelength of electromagnetic waves having a frequency at which a transmittance is highest.

9. The metasurface structure according to claim 1,
wherein a thickness between the first structure layer and the second structure layer, a thickness between the second structure layer and the third structure layer, and a thickness between the third structure layer and the fourth structure layer are 30 nm to 30 mm.

10. The metasurface structure according to claim 1, which is a sheet type lens.

11. The metasurface structure according to claim 1, which is a transmissive refraction plate.

12. The metasurface structure according to claim 2, further comprising:
a dielectric layer that is provided in at least one of a position between the first structure layer and the second structure layer, a position between the second structure layer and the third structure layer, or a position between the third structure layer and the fourth structure layer.

13. The metasurface structure according to claim 2, further comprising:
a spacer that is provided in at least one of a position between the first structure layer and the second structure layer, a position between the second structure layer and the third structure layer, or a position between the third structure layer and the fourth structure layer.

14. The metasurface structure according to claim 2,
wherein in at least one of the first structure layer, the second structure layer, the third structure layer, or the fourth structure layer, at least one metal microstructure is a metal cut wire.

15. The metasurface structure according to claim 1,
wherein in all of the first structure layer, the second structure layer, the third structure layer, and the fourth structure layer, all of the metal microstructures are the metal cut wires.

16. The metasurface structure according to claim 7,
wherein a length of the metal cut wire is 0.1 to 1.0 time a wavelength of electromagnetic waves having a frequency at which a transmittance is highest.

17. The metasurface structure according to claim 2,
wherein a thickness between the first structure layer and the second structure layer, a thickness between the second structure layer and the third structure layer, and a thickness between the third structure layer and the fourth structure layer are 30 nm to 30 mm.

18. The metasurface structure according to claim 2, which is a sheet type lens.

19. The metasurface structure according to claim 2, which is a transmissive refraction plate.

20. The metasurface structure according to claim 3, further comprising:
a dielectric layer that is provided in at least one of a position between the first structure layer and the second structure layer, a position between the second structure layer and the third structure layer, or a position between the third structure layer and the fourth structure layer.
